(19) United States
(12) Patent Application Publication
(10) Pub. No.: US 2024/0095638 A1
(43) Pub. Date: Mar. 21, 2024

(54) SOFTWARE PROGRAM SYSTEM

(71) Applicant: MyEmCalendar Inc., Whitby (CA)

(72) Inventor: Robert Conte, Whitby (CA)

(21) Appl. No.: 16/048,594

(22) Filed: Jul. 30, 2018

(51) Int. Cl. G06Q 10/0637; G06Q 10/109; G06Q 30/02; G06Q 40/06; G06Q 50/00

(52) U.S. Cl. CPC G06Q 10/0637; G06Q 10/109; G06Q 30/02; G06Q 40/06; G06Q 50/01

(57) ABSTRACT

A software product, system and method for a user to set and track lifestyle goals and related activities while collecting memories data along the way, and for a business, to gather and aggregate statistics about the user's lifestyle choices and offer access to the users lifestyle choices for a fee; comprising; matching the following through the internet; consumers and brands that interact together, through social media; the user managing receipts & expenses, goal setting and budgeting; brands to increase consumer loyalty and market awareness; organizing the user life, memories; and assisting the business to organize, market, and advertise and meet business goals.

### FIELD OF INVENTION

This invention relates to a Software Product, System and Method for a user to set and track lifestyles goals and related activities while collecting memories data along the way, and aggregates statics about the user's life style choices and offers access to the user's lifestyle choices for a fee.

### BACKGROUND TO THE INVENTION

Currently there are millions of users' of social media as well as programs that gather and aggregate statistics about lifestyle choices or personal and business goals. This invention relates to an improvement over those of existing applications and methodologies.

It is an aspect of this invention to provide a software product for a user to set and track lifestyle goals and related activities while collecting memories data along the way, and for a business, to gather and aggregate statistics about the user's lifestyle choices and offer access to the user's lifestyle choices for a fee; comprising: matching the following through the internet; consumers and brands that interact together, through social media designed on the software product; the user managing receipts & expenses, goal setting and budgeting; brands to increase consumer loyalty and market awareness; organizing the user life, memories; and assisting the business to organize, market, and advertise and meet business goals.

In one embodiment the software product software product comprises: a data base to document a user's life with a timeline that collects private and public information from data collected when the user interacts with the software product; a calendar; email Inbox; to-do's & checklists; goal management; bookkeeping; a collection of user folders, defining Memory Boxes, with an assigned email address to which the user can send documents to; and locations tracked on recorded Journeys.

In another embodiment the Memory Boxes comprise a database for gathering information about a user's time and resources invested and producing improvement data. In other embodiments the software product comprises; collecting and storing images and files to said Memory Boxes to provide the user a visual and/or textual history; the Memory Box includes metadata with source and date; and the software product includes a GPS logging system of recording locations during selected time periods.

It is another aspect of the invention to provide a software system for a user to set and track lifestyle goals and related activities while collecting memories data along the way, and for a business, to gather and aggregate statistics about the user's lifestyle choices and offer access to the user's lifestyle choices for a fee, comprising: the internet a software platform for matching consumers and brands that interact together, through social media designed on the software system; the user managing receipts & expenses, goal setting and budgeting; brands to increase consumer loyalty and market awareness; organizing the user life, memories; and assisting the business to organize, market, and advertise and meet business goals.

In one embodiment the software system comprises: a data base to document a user's life with a timeline that collects private and public information from data collected when the user interacts with the software product; a calendar, email Inbox; to-do's & checklists; goal management; bookkeeping; a collection of user folders, defining Memory Boxes, with an assigned email address to which the user can send documents to; and locations tracked on recorded Journeys.

In other embodiments the software system has Memory Boxes that comprise a database for gathering information about a user's time and resources invested and producing improvement data; the software system comprises: a device for collecting and storing images and files to the Memory Boxes to provide the user a visual and textual history; the software system's Memory Box includes metadata with source and date; and/or the software system includes an GPS logging device for recording locations during selected time periods.

It is another aspect of this invention to provide a method on a mobile platform for a user to set and track lifestyle goals and related activities while collecting memories data along the way, and for a business, to gather and aggregate statistics about the user's lifestyle choices and offer access to the user's lifestyle choices for a fee; comprising: matching the following through the internet: consumers and brands that interact together, through social media designed with the method; the user managing receipts & expenses, goal setting and budgeting; brands to increase consumer loyalty and market awareness; organizing the user life, memories; and assisting the business to organize, market, and advertise and meet business goals.

In one embodiment the method comprises:
documenting a user's life in a data base with a timeline that collects private and public information from data collected when the user interacts with a mobile platform; generating a calendar; providing an email Inbox; providing a to-do's & checklists; providing goal management;
providing bookkeeping;
generating a collection of user folders, defining Memory Boxes, with an assigned email address to which the user can send documents to; and tracking locations on documented Journeys.

In other embodiments the Memory Boxes comprise a database for gathering information about a user's time and resources invested and producing improvement data.

In yet other embodiments the method comprises; collecting and storing images and files to said Memory Boxes to provide the user a visual and/or textual history; the Memory Box includes metadata with source and date; the method includes a GPS logging system for recording locations during selected time periods.

These and other objects and features of the invention shall now be described in relation to the following drawings.

### DESCRIPTION OF THE DRAWINGS

FIG. 1 is an example of a general feature model chart flow diagram.

FIG. 2 is an example of a directory, API developer Networks chart

FIG. 3 is an example of a timeline web app dashboard

FIG. 4 is an example of a favourites web app dashboard

FIG. 5 is an example of a calendar web app dashboard

FIG. 6 is an example of an email web app dashboard

FIG. 7 is an example of a goals web app dashboard

FIG. 8 is an example of a checklists and to dos web app dashboard

FIG. 9 is an example of a finances web app dashboard

FIG. 10 is an example of a saving and coupons web app dashboard

FIG. 11 is an example of a rebates web app dashboard

FIG. 12 is an example of a discounts web app dashboard

FIG. 13 is an example of a memories web app dashboard

FIG. 14 is an example of an accepted files types chart

FIG. 15 is an example of a Login mobile app dashboard

FIG. 16 is an example of a profile mobile app dashboard

FIG. 17 is an example of a timeline mobile app dashboard

FIG. 18 is an example of a news mobile app dashboard

FIG. 19 is an example of a favourites mobile app dashboard

FIG. 20 is an example of a friends mobile app dashboard

FIG. 21 is an example of groups mobile app dashboard

FIG. 22 is an example of a calendar mobile app dashboard

FIG. 23 is an example of an email dashboard

FIG. 24 is an example of a goals mobile app dashboard

FIG. 25 is an example of a checklists and to does mobile app dashboard

FIG. 26a is an example of finances mobile app dashboard

FIG. 26b is an example of a finances mobile app dashboard

FIG. 27 is an example of savings dashboard

FIG. 28 is an example of memories mobile app dashboard

FIG. 29 is an example of a journey mobile app dashboard

FIG. 30 is an example of hashtag drawing showing health, wealth, career, hobbies, education and relationships chart.

FIG. 31 is an example of a wireframe drawing of platform website

FIG. 32 is an example of a subscription services drawing

FIG. 33 is an example of a member manager drawing

FIG. 34 is an example of a payment transactions drawing

FIG. 35 is an example of news feeds drawing

FIG. 36 is an example of a messenger services drawing

FIG. 37 is an example of a calendar services drawing

FIG. 38 is an example of an email services drawing

FIG. 39 is an example of folder services drawing

FIG. 40 is an example of an advertiser manager drawing

FIG. 41 is an example of a campaign manager drawing

FIG. 42 is an example of a wireframe chat window drawing

FIG. 43 is an example of a timeline wireframe drawing

### DETAILED DESCRIPTION OF THE INVENTION

Table of Contents

| | |
|---|---|
| INTRODUCTION | 7 |
| THE BUSINESS | 7 |
| Product Vision | 7 |
| Unique Selling Proposition | 7 |
| Benefits | 8 |
| GENERAL FEATURE MODEL | 8 |
| Platform Integration Compliance | 8 |
| Operating Systems | 8 |
| iOS | 8 |
| Android | 8 |
| Browsers Compatibility | 8 |
| Calendar Sync Services | 8 |
| Directory, API Developer Networks | 9 |
| Text Services (MMS) | 9 |
| Gateway Providers | 9 |
| Payment Gateway Services | 9 |
| PAYPAL | 9 |
| Developer Network/API | 9 |
| User Help Pages | 9 |
| Storage Limits | 9 |
| Feature Discussion | 10 |
| Security | 10 |
| Roles | 10 |
| Registration | 10 |
| Login | 10 |
| Password Reset | 10 |
| Cancellation | 10 |
| My Profile | 11 |
| My Timeline | 11 |
| Notification Badge | 11 |
| My News | 11 |
| Feed Timeline | 12 |
| My Favorites | 12 |
| Advertiser Profile Page | 12 |
| My Friends | 12 |
| Friend Profile | 12 |
| My Groups | 13 |
| Group Timeline | 13 |
| My Calendar | 13 |
| Expense Breakdown | 13 |
| Email | 14 |
| Email Features | 14 |
| File Attachments | 14 |
| Email Config | 14 |
| My Goals | 15 |
| Goal Ledger | 15 |
| Lifestyle Categories | 15 |
| # Tags | 15 |
| My Checklists & To-dos | 15 |
| My Finances | 16 |
| Product & Service Reviews | 16 |
| My Savings | 16 |
| Coupons | 16 |
| Rebates | 16 |
| Group Discounts | 17 |
| Memory Boxes: E-mail Enabled Folders | 17 |
| Accepted File Types | 17 |
| My Journey | 18 |
| PLATFORM \| WEBSITE | 18 |
| STORYBOARD | 18 |
| Arrival | 18 |
| Engagement | 18 |
| Header | 18 |
| Section 1—Stay Connected With Your Life | 18 |
| Section 2—Access Your Finances | 19 |
| Section 3—Take A Tour | 19 |
| Section 4—Get MYEMCALENDAR today for FREE | 19 |
| Section 5—Video & Download Links | 19 |
| Section 6—Earn Real Money | 19 |
| Section 7—Advertiser Links | 19 |
| Section 8—We're Real People | 19 |
| Section 9—Contact Form | 19 |
| Section 10—Footer | 19 |
| Internal pages | 20 |
| PLATFORM \| ADMIN PORTAL/CMS | 20 |
| ADMIN PORTAL/CMS FEATURES | 20 |
| 01 Subscription Services | 20 |
| 02 Member Manager | 20 |
| 03 Payment Transactions | 21 |
| 04 News Feeds | 21 |
| 05 Messenger Services | 21 |
| 06 Calendar Services | 21 |
| 07 Email Services | 21 |
| 08 Folder Services | 21 |
| 09 Advertiser Manager | 21 |
| 10 Campaign Manager | 21 |
| FUNCTIONALITY | 22 |
| 1. Interface | 22 |
| Login | 22 |
| Password Reset | 23 |
| Header | 23 |
| Logo | 23 |
| Link To My Profile | 23 |
| Logout | 23 |
| Message Notification Badge | 23 |
| 2. Feature Menu | 23 |
| 2.1. Subscription Services | 23 |
| Subscription & Expiry Process | 23 |
| Search Packages | 24 |
| Add Package | 24 |
| Filter Results | 24 |
| Browse Results | 24 |
| 2.2. Member Manager | 24 |
| Search Members | 24 |
| Filters | 25 |
| Buttons | 25 |
| Edit Member | 25 |
| Member Profile | 25 |
| 2.3. Payment Transactions | 25 |
| Gateway Transactions | 25 |
| Buttons | 25 |
| 2.4. News Services | 25 |
| Default RRS news Feeds | 26 |
| Browse XML Feeds | 26 |
| Buttons | 26 |
| Activity Report | 27 |
| 5. Messenger Services | 27 |
| Browse Complaints | 27 |
| Filters | 27 |
| Activity Report | 27 |
| 6. Calendar Services | 27 |
| Browse Calendar Gateways | 27 |
| Buttons | 27 |
| Activity Report | 28 |
| 7. Emall Service | 28 |
| Browse Email Addresses | 28 |
| Filters | 28 |
| Buttons | 28 |
| 8. Folders Services | 28 |
| Buttons | 28 |
| 9. Advertiser Manager | 29 |
| Search/Browse Advertisers | 29 |
| Filters | 29 |
| Buttons | 29 |
| Edit/Delete Advertiser Profile | 29 |
| Locations | 29 |
| Statistics Generator | 29 |
| 10. Campaign Manager | 29 |
| Search/Browse Campaigns | 29 |
| Filters | 29 |
| Buttons | 30 |
| Edit/Delete Campaign | 30 |
| Ad Programs | 30 |
| Coupon/Rebate/Discount | 30 |
| SMS | 30 |
| Email | 30 |
| Proximity | 30 |
| 11. System | 31 |
| Users | 31 |
| Search Users | 31 |
| Filter Results | 31 |
| Permissions | 31 |
| Settings | 31 |
| PLATFORM \| WEB APPLICATION | 32 |
| FEATURES | 32 |
| PLATFORM \| MOBILE APP | 36 |
| FEATURES | 36 |
| CHAT & TIMELINE | 42 |
| CHAT WINDOW | 42 |
| Wireframe | 42 |
| Features | 42 |
| Inteli-Links | 42 |
| TIME LINE | 42 |
| Features | 42 |
| Start Date | 43 |
| Search | 43 |
| Privacy Policy | 43 |
| Post | 43 |
| Inteli-Links | 44 |
| NOTIFICATION TEMPLATES | 44 |
| SECURITY | 44 |
| Welcome Message | 44 |
| Lockout Notification | 44 |
| Password Reset | 44 |
| Expiry Email | 45 |
| Cancellation Notice | 45 |
| SOCIAL NETWORKING | 45 |
| Message Notification | 45 |
| Posting Notification | 45 |
| STORAGE NOTIFICATIONS | 45 |
| 100 Mb Warning | 45 |
| 0 Mb Warning | 45 |
| SAVINGS NOTIFCATIONS | 46 |
| Savings Notification—Coupon | 46 |
| Savings Notification—Rebate | 46 |
| Savings Notification—Group Discount | 46 |
| Savings Notification—Group Purchase | 46 |
| Savings Notification—Cancellation | 46 |
| Calendar Events | 46 |
| PLATFORM \| WEBSITE | 47 |
| GENERAL FEATURE MODEL CHART WIREFRAME | 47 |
| DIRECTORY, API DEVELOPER NETWORKS CHART | 48 |
| PLATFORM \| WEB APPLICATION | 49 |
| My Timeline | 49 |
| My Favourites | 50 |
| My Calendar | 51 |
| My Emails | 52 |
| My Goals | 53 |
| My Checklists & To-dos | 54 |
| My Finances | 55 |
| My Savings | 56 |
| Coupons | 56 |
| Rebates | 57 |
| Discounts | 58 |
| My Memories | 59 |
| Accepted File Types Chart | 59 |
| PLATFORM \| MOBILE APP | 60 |
| WIREFRAMES | 60 |
| Login | 60 |
| My Profile | 61 |
| My Timeline | 61 |
| My News | 62 |
| My Favorites | 63 |
| My Friends | 63 |
| My Groups | 64 |
| My Calendar | 64 |
| Email | 65 |
| My Goals | 66 |
| My Checklists & To-dos | 66 |
| My Finances | 67 |
| My Finances | 68 |
| My Savings | 69 |
| My Memories | 70 |
| My Journey | 71 |
| HASHTAG DRAWING SHOWING HEALTH, | 72 |
| WEALTH, CAREER, HOBBIES, EDUCATION | |
| AND RELATIONSHIPS CHART | |
| WIREFRAME DRAWING OF PLATFORM/WEBSITE | 73 |
| SUBSCRIPTION SERVICES DRAWING | 74 |
| MEMBER MANAGER DRAWING | 74 |
| PAYMENT TRANSACTION DRAWING | 75 |
| NEWS FEEDS DRAWING | 75 |
| MESSENGER SERVICES DRAWING | 76 |
| CALENDAR SERVICES DRAWING | 76 |
| EMAIL SERVICES DRAWING | 77 |
| FOLDER SERVICES DRAWING | 77 |
| ADVERTISER MANAGER DRAWING | 78 |
| CAMPAIGN MANAGER DRAWING | 79 |
| WIREFRAME CHAT WINDOW DRAWING | 80 |
| TIMELINE WIREFRAME DRAWING | 81 |

### Introduction

The Business

MYEMCalendar is a new start up like never before. The product redefines how:
1. Consumers and the brands that they love interact, together, through social media;
2. People manage receipts & expenses, goal setting and budgeting;
3. Brands increase consumer loyalty and market awareness;
4. You and I organize our lives, memories and more; and
5. Businesses wilt organize, market, advertise and help them soar to success.

### All in One!

MYEMCalendar is a lifestyle app for the IOS and ANDROID mobile platforms that allows a user to set and track lifestyle goals and related activities while collecting “memories” along the way.

As a business, MYEMCalendar gathers and aggregates statistics about these lifestyle choices and offers access to that information for a fee.

Product Vision

Millions of users around the world use MYEMCalendar to track all of the important things that they need to know and remember in their lives. Beyond a useful, personal accounting and budgeting tool, MYEMCalendar saves users money each and every day giving them access to exclusive group discounts, coupons and rebates from their favorite brand retailers, chain stores and restaurants.

A calendar not only for today, this month or this year but, FOR LIFE!

MYEMCalendar is a lifestyle product that documents your life inside of a TIMELINE. The TIMELINE collects private and public information from data collected when the user interacts with the application:
Calendar;
Email Inbox;
To-do's & checklists;
Goal management;
Bookkeeping;
A collection of user folders, called Memory Boxes, with an assigned email address to which the user can send documents to; and
Locations tracked on recorded Journeys.

Unique Self Proposition

Use MYEMCalendar to record your purchases at favorite brand retailers, chain stores and restaurants and you can consume as much or more for less than what you're spending, now.

Benefits

A user adopts the MYEMCalendar as a means of better organizing their time, information and money with the intent to increase the quality of their lifestyles.

The general success formula will require a simple workflow that allows the user to:
Set personal goals;
Prioritize their time into planned events and tasks that lead the user towards achieving those goals by a certain date;
Document their life Journey by gathering Information about how their time and money was invested offering insights and opportunities for improvement;
Socializing with other members who share common interests and goals to inspire action.
Bookkeeping; and
Remember how things looked along the way by collecting images and files inside of folders, called MEMORY BOXES,

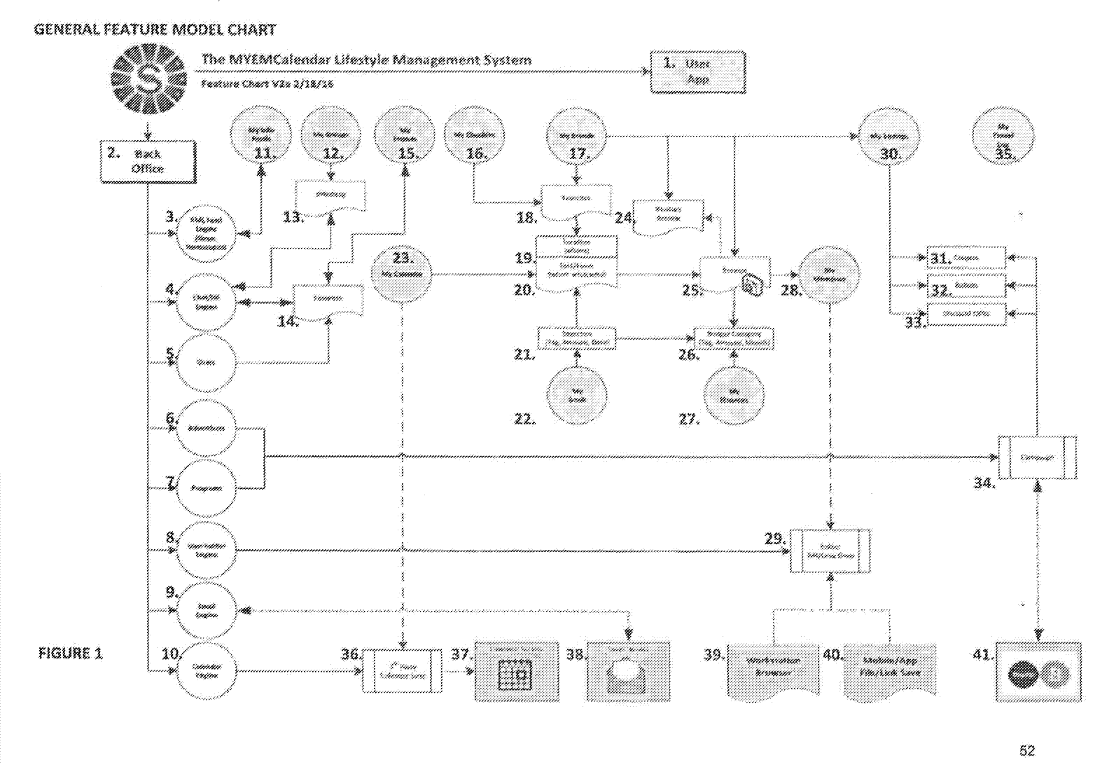

FIG. 1 is a General Feature Model Chart

Platform Integration Compliance

Operating Systems

MYEMCalendar will allow users to access functionality through a smart phone app accessible on these platforms:

IOS
IOS 8 and above

Android
Android 4.4 and above

Browsers Compatibility

MYEMCalendar will allow users to access its functionality through contemporary web browsers, including:
Chrome, Mozilla & Safari Browser (−2 versions at time of launch);
Desktop & Tablet Orientations; and
Responsive to tablet orientation only

Calendar Sync Services

Users will also be able to import 3^{rd} party calendar events into their MYEMCalendar from the following services providing a suitable API is available:
Gmail;
Yahoo Mail; and
Outlook Live

Directory, API Developer Networks Ranking

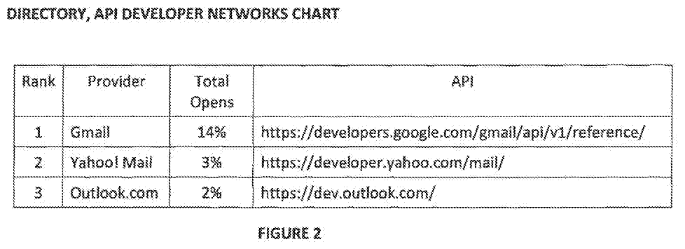

FIG. 2 is a Directory, API Developer Networks Chart

Text Services (MAO
MYEMCalendar will utilize text-based communication for registering and verifying accounts, as well as communicating savings opportunities to members (ie Flash Sales). A 3^{rd} party service is required to manage the communications between the server and TELECOMS.

Gateway Providers
http://smsglobal.com/pricing/|http://www.smsglobal.com/mms-api/

Payment Gateway Services

Paypal
The initial deployment of MYEMCalendar will use PayPal Pro for its payment gateway services taking advantage of its subscription processing capabilities.

Developer Network/API
http://developer.paypal.com/

User Help Pates
Application pages can standardize on a question mark icon that links to support content on the MYEMCalendar Website specific to the features and functions of interest;
This project wilt include 10 basic HTML pages of about 200 words and 3 images, each, to begin that content library:
   1. How To Manage Your MYEMCalendar Email Addresses;
   2. How To Manage Goals;
   3. How To Manage Memory Boxes;
   4. How To Manage Your Finances;
   5. How To Manage Your Checklists & To-dos;
   6. How To Apply Your Savings Opportunities;
   7. How To Connect With Friends;
   8. How To Connect With Groups;
   9. How To Manage Your Activity Planning; and
   10. How To Use The MYEMCalendar Messenger;

Stowe Limits
The system will reject any uploads or emails with attachments that exceed a user's available data storage:
   Uploads will fail with a warning;
   User will be notified that (SENDER) sent an email but the user doesn't have storage capacity to accept it

Feature Discussion

Security

Roles
Super Administrator (DIT);
Administrator (DITs Client);
Advertiser (Member, special privileges)—Members assigned with ADVERTISER privileges will be able to access ADVERTISER profiles limited to only those which they're associated with.
Member (General User);

Registration
Members must download and register through the mobile app, first before being able to access the website functionality;
For the purposes of development, an ADMINISTRATOR will be able to create a MEMBER user in the CMS for the purposes of accessing and testing the Web Application

Login
Users can attempt a login 3 times before being locked out for 5 minutes. An email notification will be sent to their outside email address notifying them of the lockout.

FIG. 15 is a Login Mobile App

Password Reset
Upon requesting a password reset, users will receive a link in their outside email address;
Users may also opt for an SMS code-based reset; and
Users will receive an email notification that their password was reset including a link to reset it again if they think such an action was carded out fraudulently.

Cancellation
A user may choose to cancel their account at any time by choosing the option found on their account profile—an email will be sent to their primary OUTSIDE email address to verify that they want to shut down the account;
The account will be immediately suspended and a notification emailed to their outside email address with a 30 day unlock link;
Users will have 30 days to log back in and change their status back to ‘active’. If they don't reactivate the account, then the termination date will be time-stamped for the current date on their member record and the status changed to “CANCELLED”,

My Profile
User can edit their personal profile information;
NOTIFICATIONS ON/OFF—emails user to FORWARDing address whenever the BADGET notification is affected;
FORWARD MYEMCalendar Mail To—3^{rd} party email address for notifications;
CALENDAR SYNC URL—used to update/sync MYEMCalendar with 3^{rd} party appointments;
Visible/Invisible—Visible makes user ‘friend’ searchable;

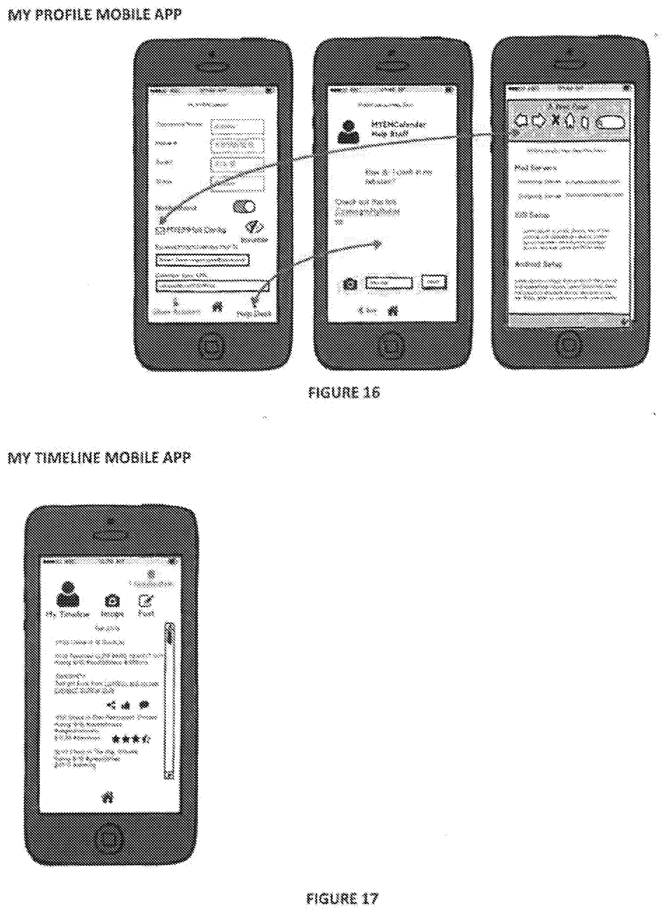

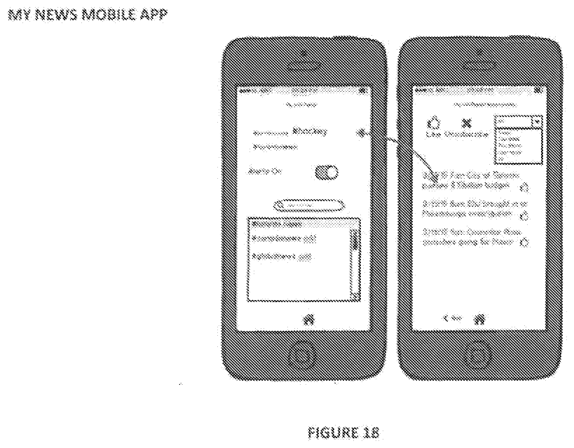

FIG. 16 is My Profile Mobile App

My Timeline

Notification Badge

Each platform interface will have a badge icon notifying the user of recent messages. These message notifications appear in the user's timeline on which they can click and be forwarded to the appropriate feature interface:
New Email
New Memory Box Post
New Instant Message
New Timeline Post/Share
New Shared Appointment
New Savings Opportunity
Calendar Event Alert

Once the notification is displayed on the timeline OR the user accesses the feature interface (such as email) then the badge notification will be removed.

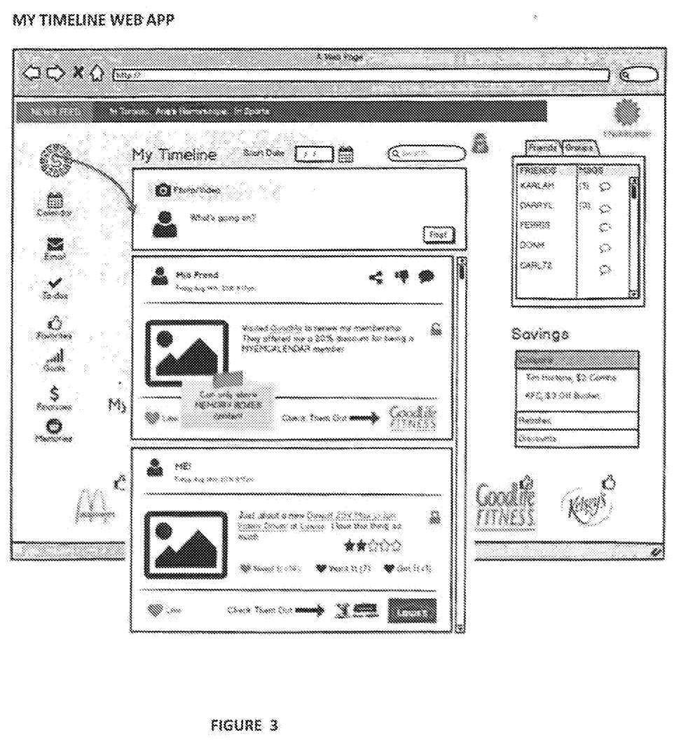

FIG. 3 is My Timeline Web App

FIG. 17 is My Timeline Mobile App

My News
Displays list of news feeds subscribed to—click on a feed and the user is taken to the feed timeline;
Allows user to subscribe to new feeds;

Feed Timeline
User can unsubscribe by clicking LIKE icon;
PERIOD—user can select how far back they want to look at feed history (dependent on 3^{rd} party service provider capabilities);
LIKE—Feed article shared on user's timeline;

FIG. 188 is My News Mobile App

My Favorites
Displays list of LIKED brands—by clicking on the brand, the user is taken to that Advertiser's profile page;
Allows user to LIKE registered Advertiser brands;

Advertiser Profile Page
Like—clicking on this icon removes this Advertiser from Favorites;
Locations—displays map, centred on user's current position, showing Advertiser locations
Savings—lists available coupons, rebates & discount opportunities specific to Advertiser; and
Timeline—take user to Advertiser timeline;

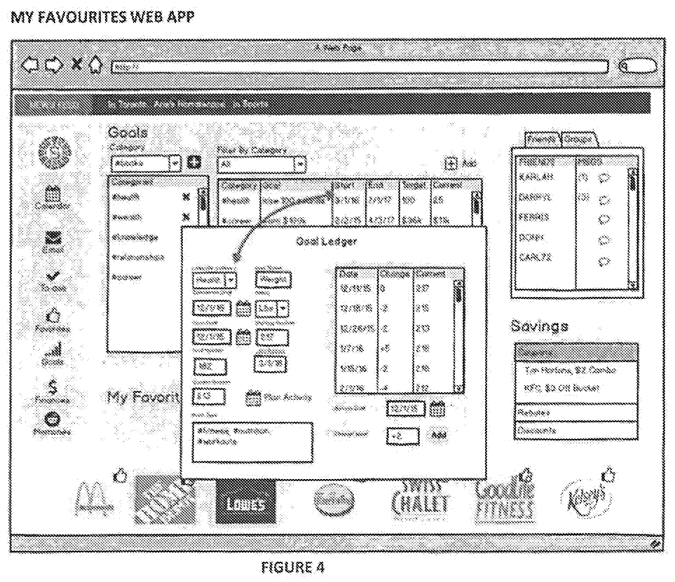

FIG. 4 is My Favourites Web App

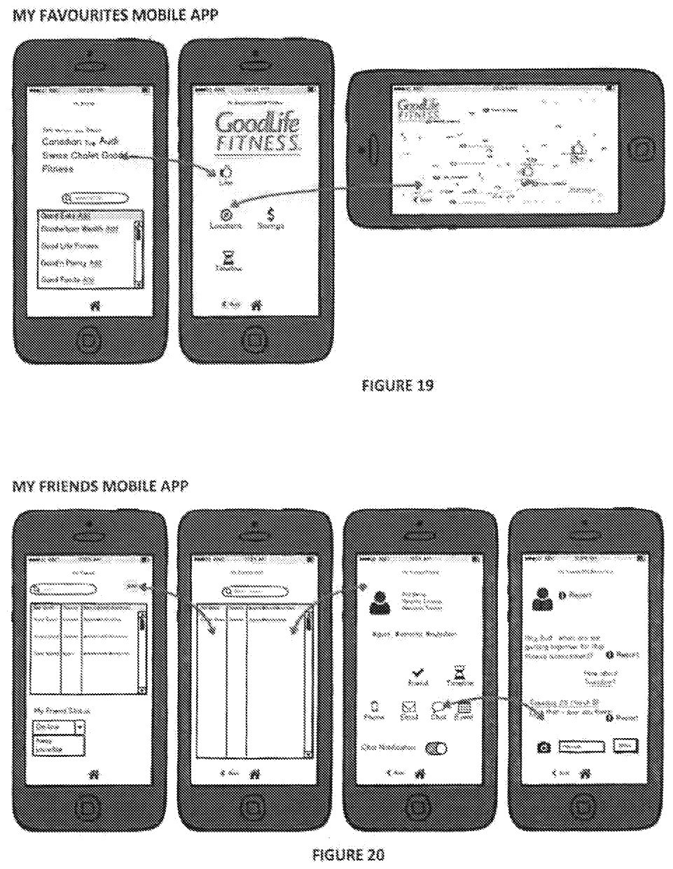

FIG. 19 is My Favourites Mobile App

My Friends
Search members that are visible;
Add user to FRIEND lists;
Set On-line Status to Away or Visible—display switch for interacting with existing friends only;
Click on Friend takes you to their profile;

Friend Profile
Press LIKE iron to UNFRIEND them;
Timeline takes user to FRIEND'S timeline;
Phone—initiates a phone call;
Email—populates a MYEMCalendar email form;
Chat—initiates an instant messaging session with FRIEND;
Calendar—initiates a shared event with FRIEND;
Chat Notification—ON ensures that the Notification Badge is updated IF this FRIEND sends a chat message.

FIG. 20 is My Friends Mobile App

My Groups
Display a list of Groups that user has subscribed to and link to Group timeline if selected;
Allow user to search and subscribe to available groups or create a new one;

Group Timeline
Clicking on LIKE icon will unsubscribe them from Group;
Period—allows user to jump to past posts;
Add Photo/Video—allows user to post picture or video to group;
Send—posts text entry to timeline.

FIG. 21 is My Groups Mobile App

My Calendar
Views: Monthly, Weekly, Daily displaying color coded events;
Sync With External Calendar—using URL feature from MY PROFILE, the calendar adds V party events to the users MYEMCalendar;
Location—links to map, allows user to search/select from FAVORITE locations//allows user to LIKE/UNLIKE location (making/unmaking it a FAVORITE location)//clicking on COMPASS icon opens up a map showing current location and destination (mobile app only);
Invite—allows user to select a FRIEND//event automatically appears on Friend's calendar and notifies them of event;
Goal: allows user to search/select active GOALs, PENCIL icon allows user to add to associated GOAL ledger;
Add Image; allows user to upload receipt picture;
Color Selector: allows user to select background color for this event for display purposes;

Expense Breakdown
Allows user to associate expense with an Advertiser's brand (i.e. restaurant) and an expense account from FINANCE—clicking on PENCIL icon allows user to break down expense Into multiple categories;
User is presented with an amount starting with the receipt amount that is reduced with each line item—auto populates next line with balance to expense; and
Multiple category feature allows a 4-star rating per line

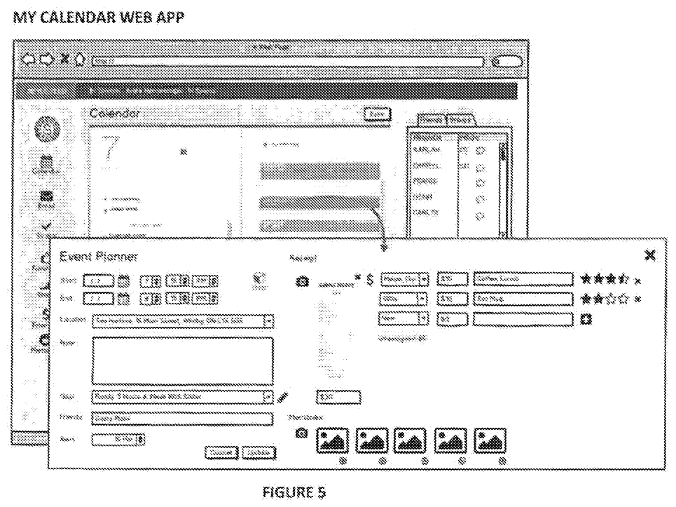

FIG. 5 is My Calendar Web App

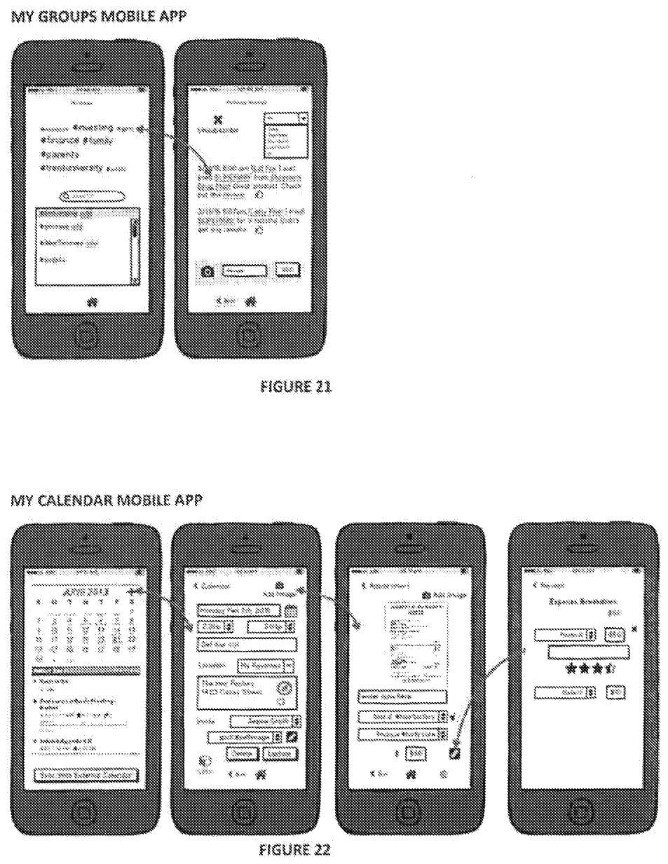

FIG. 22 is My Calendar Mobile App

Email
Each user has a primary MYEMCalendar email address—[unique record ID @ myemcalendar.com];
Additional MYEMCalendar alias email addresses can be created but they all flow into the primary inbox;
Alias emails can be created after an evaluation process to verify that they are available—users can't hoard them, they have to be assigned as a primary or to a MEMORY BOX immediately in order to keep them;
Only MYEMCalendar emails are managed inside of the MYEMCalendar application;
MYEMCalendar emails can be forwarded to outside email addresses;
Smart Device: Swiping LEFT on an email in a list presents the option to delete it; Web Application allows for bulk select/delete;

Email Features
Each email address has its own inbox, sent, drafts, trash and flagged folders;
Clicking on a STAR icon flags/unflags an email;
Clicking on a LOCK icon prevents it from being deleted, clicking again unlocks the email for deletion;
Clicking FORWARD icon auto-populates a new email's TO function with the sender of the associated email;
Clicking FORWARD ALL icon auto-populates a new email's TO and CC: function with destination content from associated email;
Clicking DOWNLOAD icon initiates a download function on a PC browser and opens the file on a smart device (where possible);
Clicking ATTACHMENT icon allows user to select a file to with the email from a PC only; otherwise it's a picture/video on a smart device

File Attachments
Maximum 5 Mb;
See MEMORY BOX feature for acceptable file types;

Email Config
Include Original Text—adds text from associated email BELOW user-added text;
Forward To—system copies all correspondence received from this email address to outside email address;
Assign To—assigns alias to primary or a MEMORY BOX;

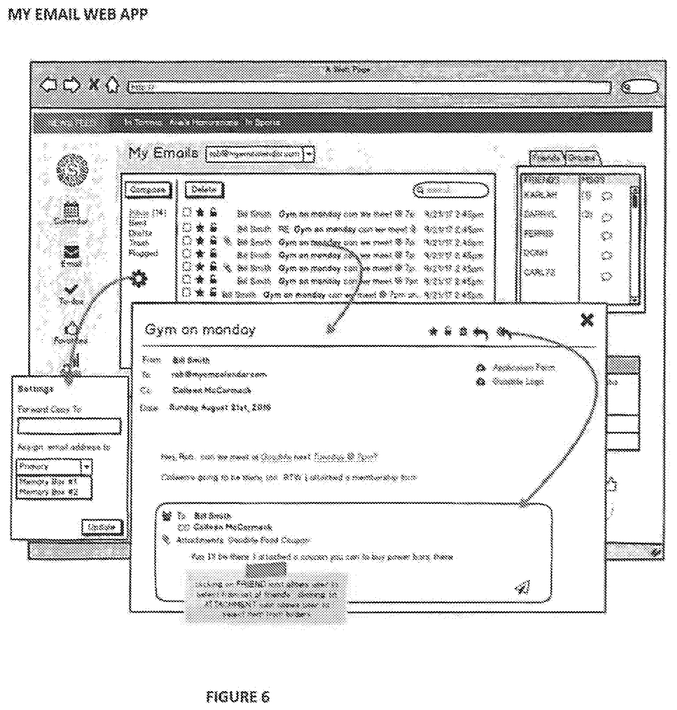

FIG. 6 is My Email Web App

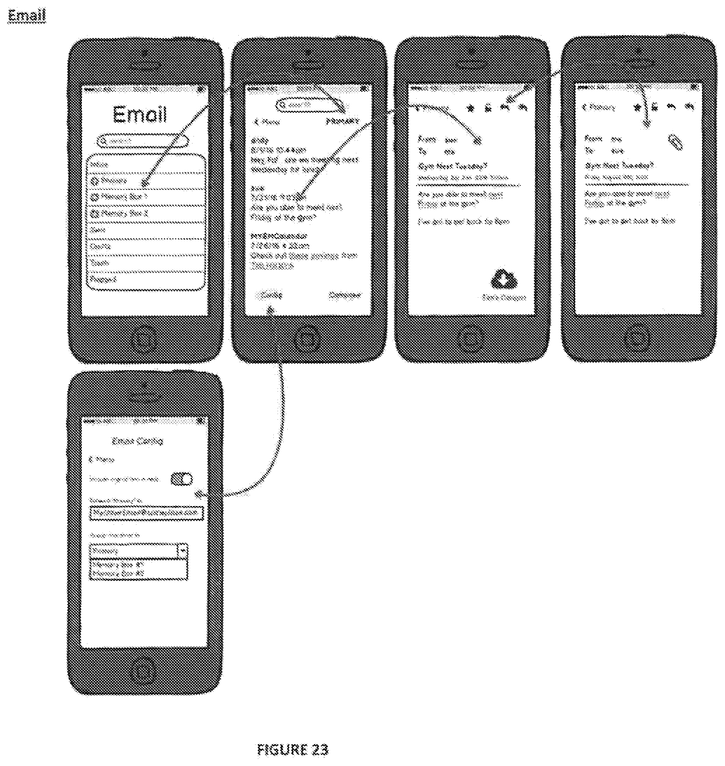

FIG. 23 is My Email Mobile App

My Goals
The user is presented with a list of current goals and quickly filter ACTIVE, COMPLETE and INCOMPLETE;
Goals are grouped by LIFESTYLE CATEGORIES and subcategorized by hashtags—both of which help users find other members with similar goals;
Selecting the PLAN ACTIVITY icon generates an event auto-populating the GOAL association;
TRACKING METRICS dropdown (Lbs, Kg, $, Each)—this list will be editable in the CMS;

Goal Ledger
This feature allows the user to record measured progress in achieving a goal;
Clicking on a LEDGER item in a list allows user to edit it;
Clicking the CALENDAR icon opens up the event that this particular ledger value is associated with;

Lifestyle Categories

Lifestyle Categories are used within the system to group activities and goals:
Health—physical, emotional and spiritual needs of an Individual.
Wealth—financial needs of an individual.
Career—need for an individual to be productive and engaged in some form of life's work
Hobbies—need to express themselves through engaging play activities.
Education—needs to better understand the world about them.
Relationships—needs to engage with family, friends, co-workers, customers, suppliers, etc.

FIG. 7 is My Calendar Web App

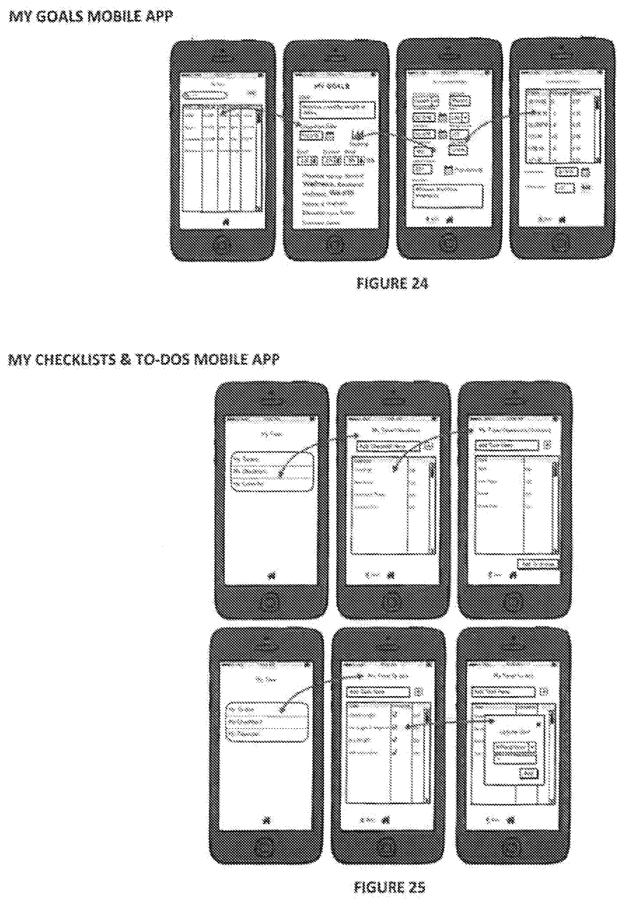

FIG. 24 is My Calendar Mobile App

# Tags

Members relate bits and pieces of information along their journey by way of hashtags. These hashtags also form the relationships among different users.

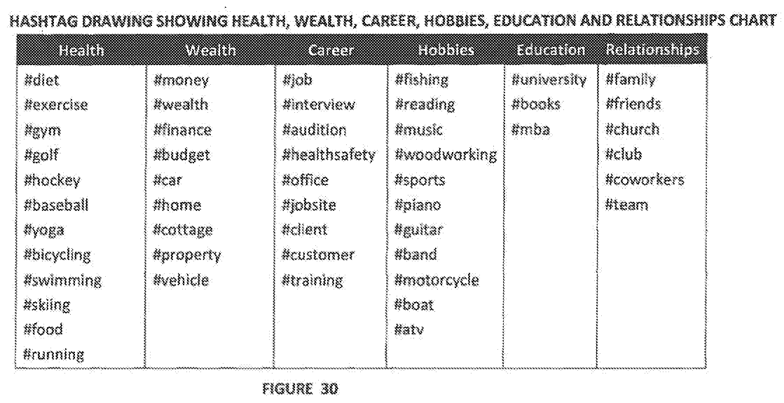

FIG. 30 is a Hashtag Drawing Showing Health, Wealth, Career, Hobbies, Education and Relationships Chart

My Checklists & To-Dos
A CHECKLIST is a collection of individual to-do's (le shopping list, equipment list, travel list);
The CHECKLIST LIBRARY is a collection of CHECKLISTS that the user can browse through and revise (ie Basic Shopping list, My Camping Checklist, My Travel Checklist);
There will always be a default CHECKLIST called “ACTIVE” which a user can copy a CHECKLIST's Individual to-do Items into;
The user can add/remove a to-do item from the ACTIVE list;
When clicking on the COMPLETE icon, the user is presented with a form allowing the user to add a value to a specific GOAL ledger;

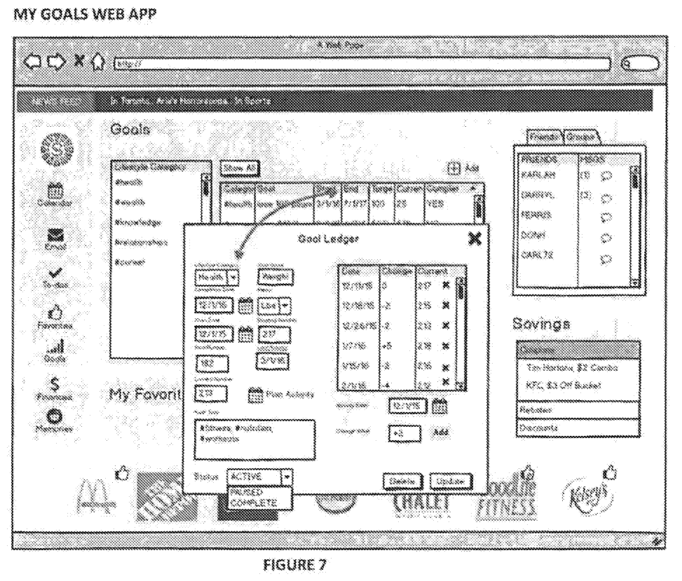

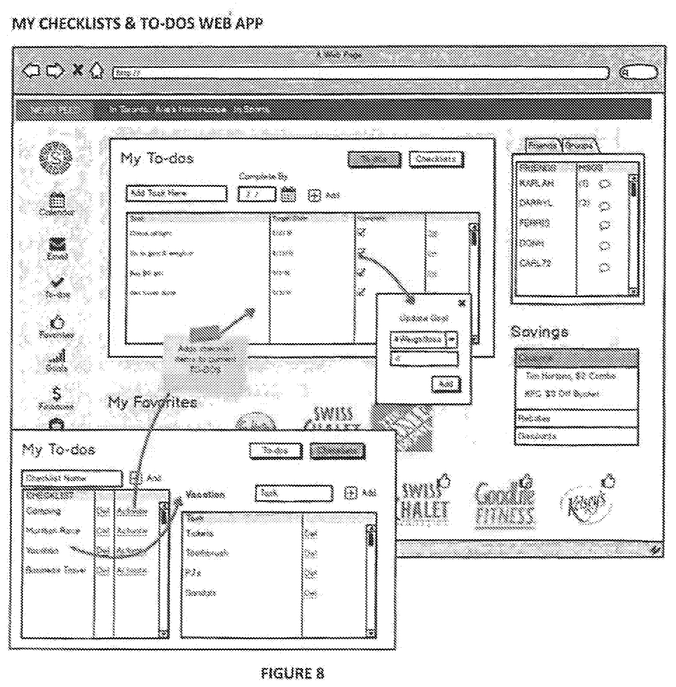

FIG. 8 is My Checklists & To-Dos Web App

FIG. 25 is My Checklists & To-Dos Mobile App

My Finances
User creates list of hashtag “accounts” that can be associated with journal entries;
Accounts can be combined into GROUPS;
Account Ledgers show individual journal entries;
Date Period filtering is done by MONTH and YEAR;
Group Ledgers show sum values for each Account;
Journal Entries allow user to upload a receipt or cross reference with receipt found on associated EVENT—a CALENDAR icon will appear if there's an EVENT associated with it and by clicking on it then that EVENT will open up;

Product & Service Reviews

When members register an expense and associate it with a MYEMCalendar recognized brand then they will be prompted to create a review for a product or service. These reviews will appear on timelines for any user that subscribes to the associated hashtag for that brand

FIG. 9 is My Finances Web App

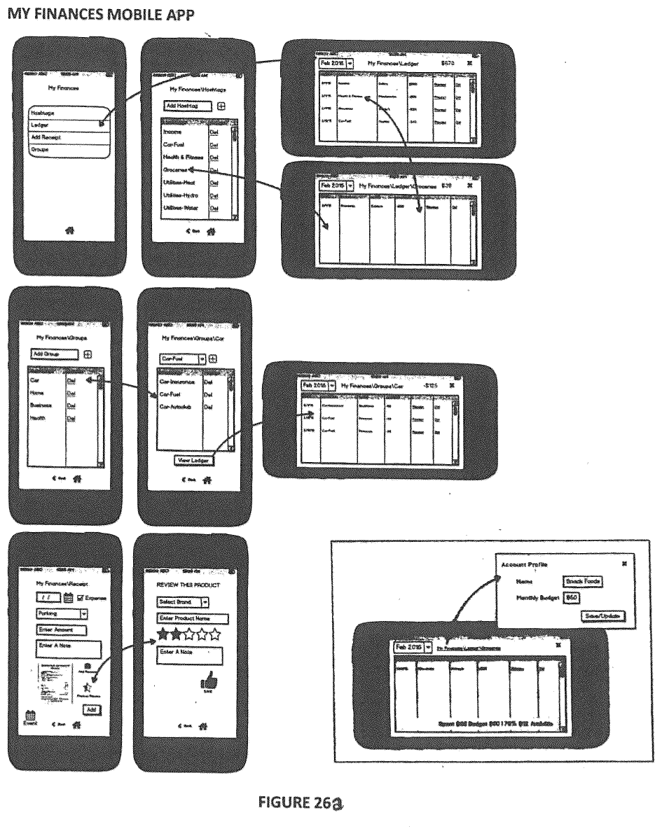

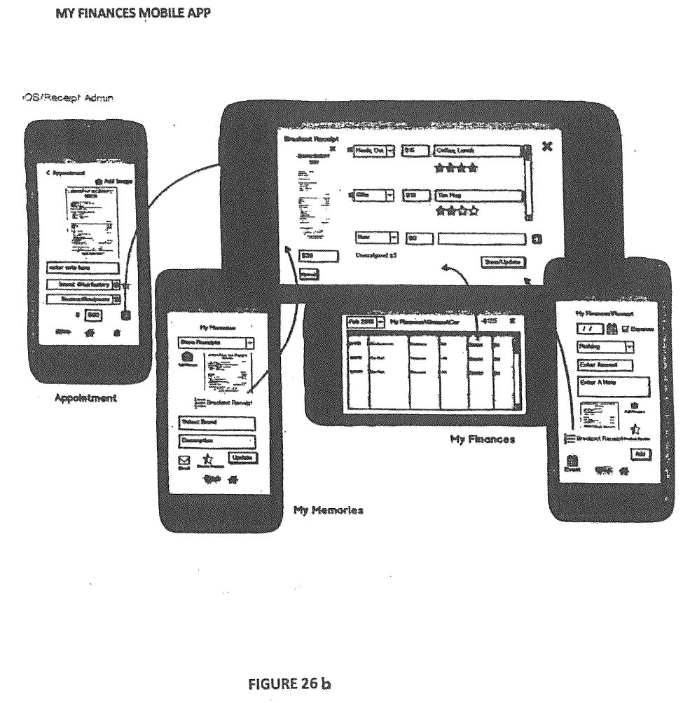

FIG. 26 is My Finances Mobile App

My Savings

This feature allows the user to monitor Incoming coupons, rebates and group discount opportunities.

Coupons
Users will receive coupons based on ADVERTISER CAMPAIGNS that they are associated with. Coupons can be applied in the real world by providing a barcode for scanning from their app. There is no mechanism at this time for allowing an advertiser to cancel a coupon (1-time use function not part of this design);

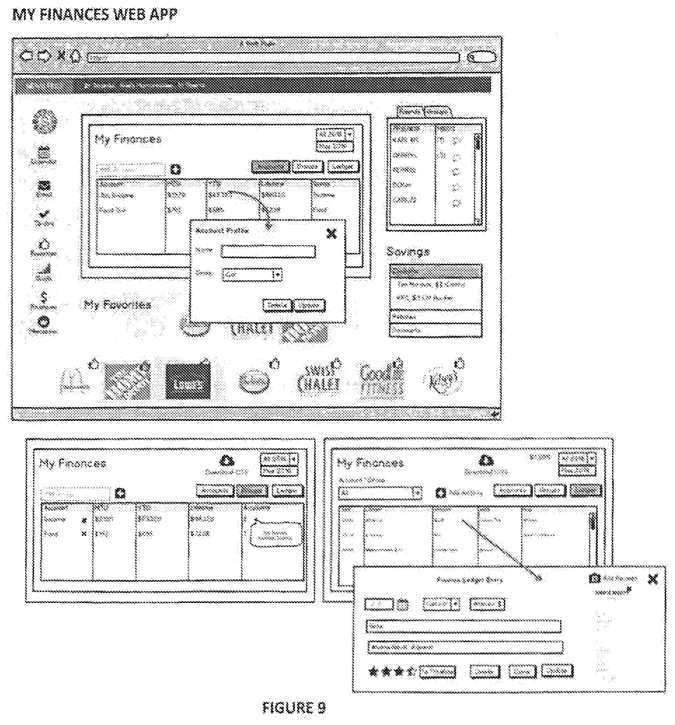

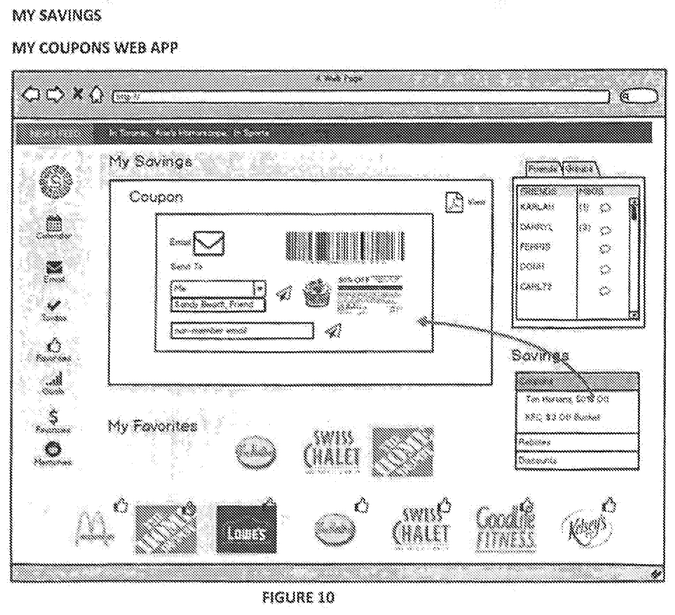

FIG. 10 is My Coupons Web App

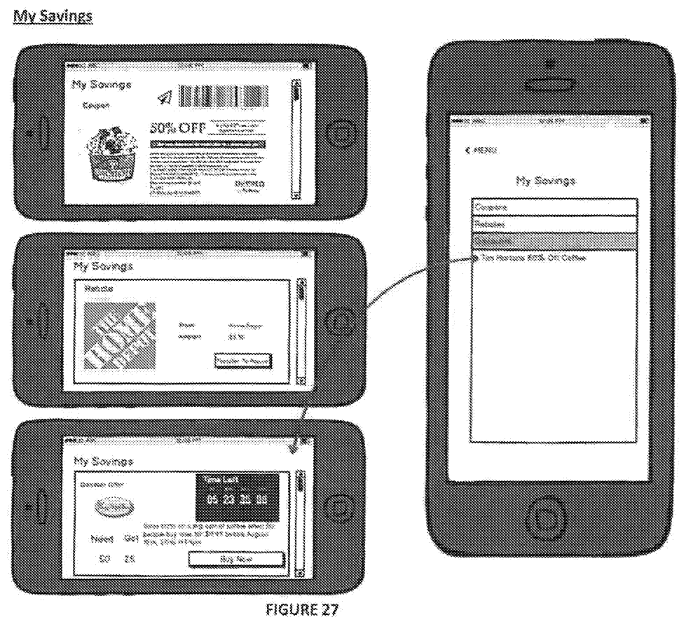

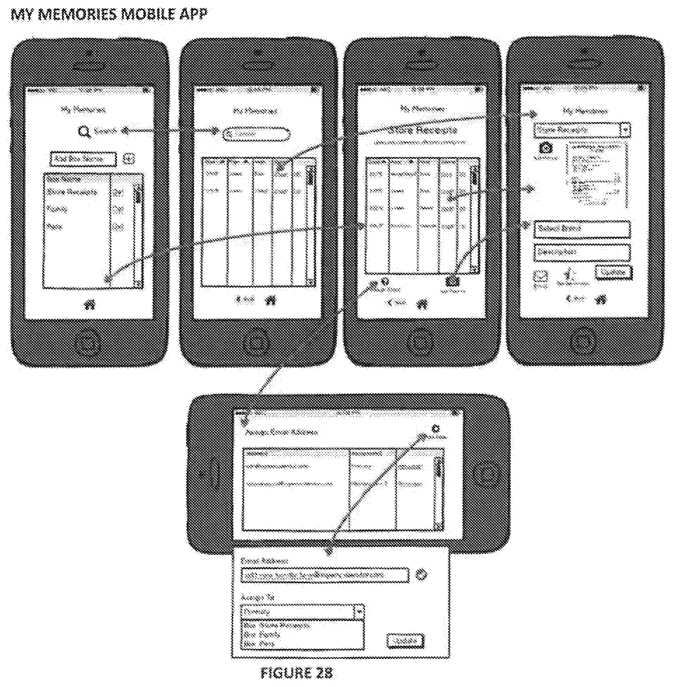

FIG. 27 is My Savings Mobile App

Rebates
Users will receive rebates based on ADVERTISER CAMPAIGNS that they are associated with. Rebates can be redeemed immediately through a PAYMENT GATEWAY.
MYEMCalendar has collected the rebate dollars from the advertiser and deposit them in its bank prior to the start of the ADVERTISER CAMPAIGN. The rebate amounts are transferred via the PAYMENT GATEWAY from the associated MYEMCalendar account to the user's gateway account that they've stored on their MEMBER PROFILE;

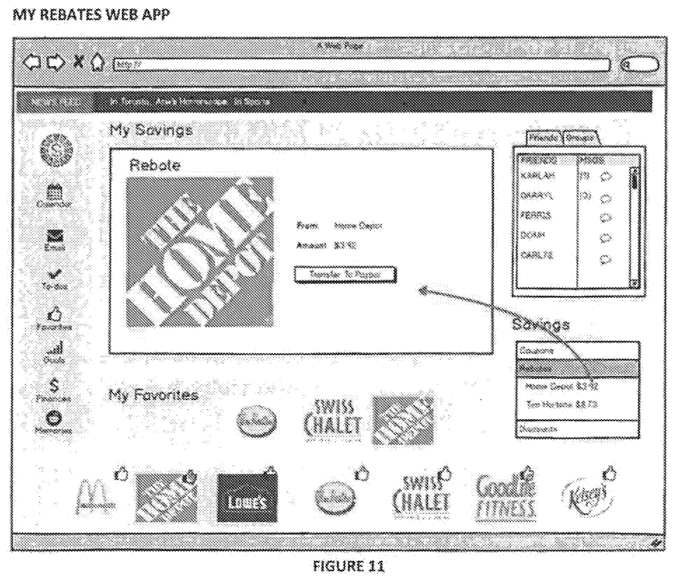

FIG. 11 is My Rebates Web App

Group Discounts
Members can browse group purchase opportunities and commit to purchasing them IF a minimum number of other users purchase the product or service as well. The user's money is transferred immediately upon commitment and, if the opportunity expires without enough purchasers, then the payment is refunded immediately;
Timer counts down number of days, hours and minutes until opportunity expires, as well as number of people required (Need, Got);

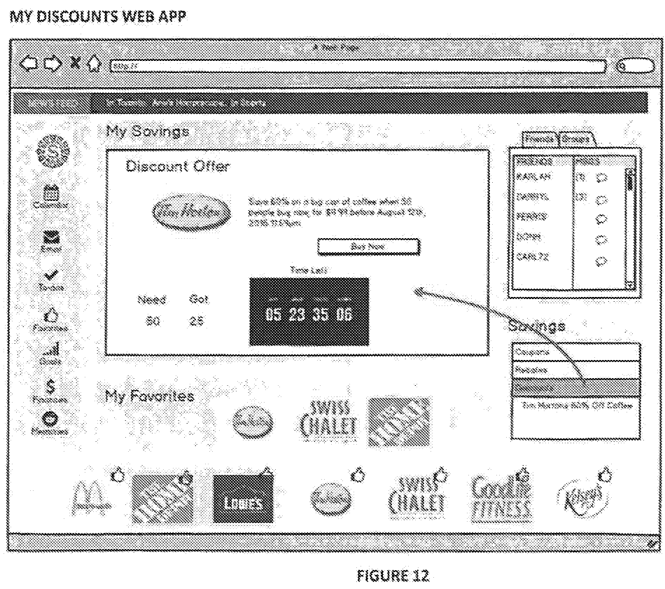

FIG. 12 is My Group Discounts Web App

Memory Boxes: E-mail Enabled Folders

A memory box is the equivalent of a desktop computer folder capable of storing any type of digital file. The file can either be uploaded through the application, or emailed as an attachment to an alias associated with that folder.
An pop server receives a MYEMCalendar domain email;
The receiver's email is compared against available member email addresses and if there's a matching folder then the document is parsed and the attachment copied into associated Memory Box with metadata indicating Its source and date;
The user is notified that they've received the file into their folder, and
The original email can be viewed in the user's INBOX and deleted without affecting the file stored in the associated Memory Box

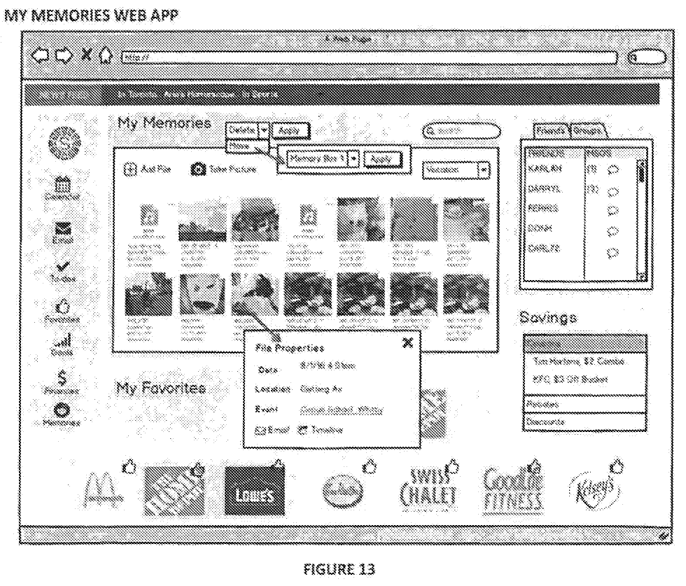

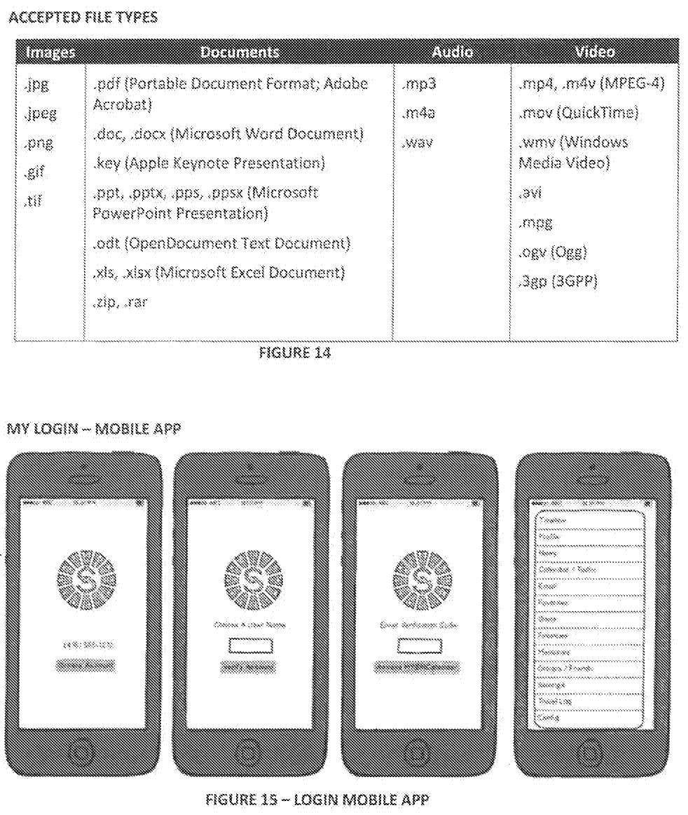

FIG. 13 is My Memories Web App

FIG. 23 is My Memories Mobile App

FIG. 14 is an Accepted File Types Chart

My Journey
This feature is a GPS logging system that records locations about every 5 minutes;
User's create/stop a JOURNEY and JOURNEY data points can be viewed on a map with date/times superimposed;
For an ACTIVE JOURNEY, the user can see themselves superimposed on a map that also displays business names;
The user can CHECK IN to a business and that business is added to MYEMCalendar's list of business/brand names—when a user clicks on a CHECK IN icon then a page pops up with the business logo—press the LIKE icon to add it to FAVORITES; press CHECK IN icon to register the check-In;

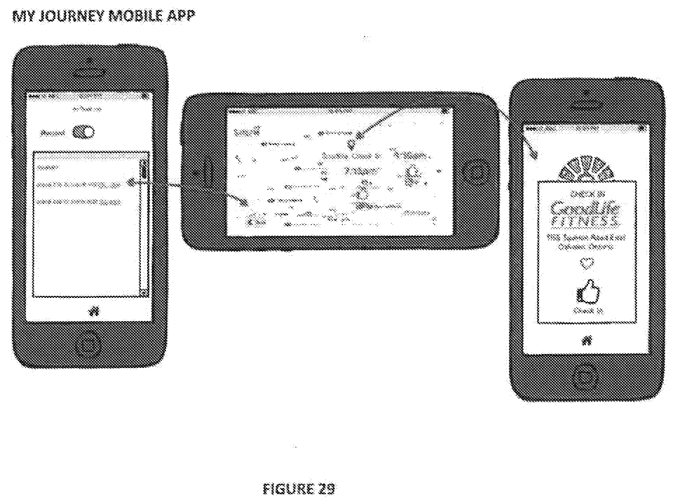

FIG. 29 is My Journey Mobile App

### Platform|Website

Storyboard

Arrival

Visitor has arrived by typing in URL directly or from a 3^{rd} party link, such as a partner site or search engine results list.

Engagement

Header

Image|Social Media Icons|Web App Links
Email: supportmyemcalendar.com
Linkedin; https://linkedin.com/myemcalendar
Twitter: https://twitter.com/Myemcalendar
Facebook: https://en-pl.facebook.com/Myemcalendar-566068726853S37
LOGO: when clicked on, a pop-up consumes the entire width of the page with logo centred to the browser's maximum height and width in all responsive scenarios.

Section 1—Stay Connected with Your Life

Single Image|Floating Pop-Up|Ticker-Style Twitter Feed

Thematically, the visitor is presented with the Idea of an abundance of free time to pursue what ever activity they choose because the MYEMCALENDAR is keeping the person organized and hitting their goals on schedule;
Pop-up connects user to an enrolment landing page (simple form required) allowing visitor to apply to become a beta tester—this will be removed once the testing phase begins;
Twitter feed shows and links (Twitter.com) to first sentence of post; and

Section 2—Access You Finances . . .

Text
Simple text block on sari background color.

Section 3—Take A Tour

Text Block|Animated Feature
Centre calendar shows current month with TODAY highlighted;
As visitor hovers over various, parts of image then icons display short descriptions;

Section 4—Get MYEMCALENDAR Today for Free . . .

Text
Simple text block on solid background color;

Section 5—Video & Download Links

Video|Sign-Up Form|Download Links
Youtube or Vimeo) video source;
News alert sign-up form connects to Mailchimp account;
Download links point to app-specific on-line store URLs;

Section 6—Earn Real Money . . .

Text
Simple text block on solid background color;

Section 7—Advertiser Links

Text|Carousel|Button
Images in carousel generated from database table of featured advertisers;
Button, “Become A Preferred Advertiser”, links to advertiser landing page;

Section 8—We're Real People . . .

Text
Simple text block on solid background color;

Section 9—Contact Form
Emailed to suppart@myemcalendar.com

Section 10—Footer

Image|Text|Links|Social Media Icons
The download link takes visitor up to SECTION 5 of the homepage;
PRIVACY POLICY links to internal privacy policy page;
TERMS OF USE links to internal terms of use page;
DIT CANADA links to https://ditcanada.com

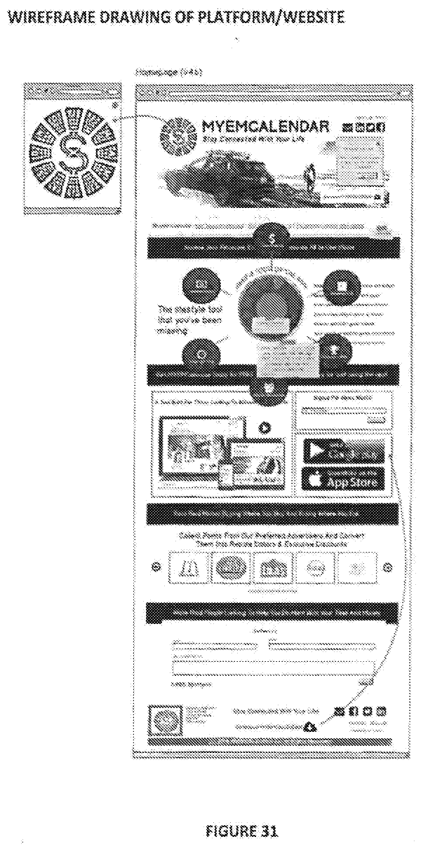

FIG. 31 is a Wireframe Drawing of Platform/Website

Internal Pages

The following internal pages will be developed based on a simple page design with homepage header & footer elements:
Membership Packages & Subscription Purchase (logged in members only)—simple internal page with list of subscription packages—click on price and it initiates a Paypal transaction;
Beta Team Application;
Advertiser Application Page;
Privacy Policy; and
Terms Of Use

Platform|Admin Portal/CMS

The purpose of the CMS web application is to provide administrative access to features and functions that allow for the management of members and related services.

Admin Portal/CMS Features
1.1. Interface
   1.1.1. Login
   1.1.2. Header
      1.1.2.1. Logo
      1.1.2.2. Link To MY PROFILE
      1.1.2.3. Logout
      1.1.2.4. Message Waiting Notification
1.2. Feature Menu
   1.2.1. Subscription Services
      1.2.1.1. Search Packages
      1.2.1.2. Add Package
      1.2.1.3. Fitter Results Set
         1.2.1.3.1. Clear Filter
      1.2.1.4. Browse Results
         1.2.1.4.1. Edit Package
         1.2.1.4.1.1. Delete Package
         1.2.1.4.2. Subscriber List
         1.2.1.4.2.1.1. Export CSV
   1.2.2. Member Manager
      1.2.2.1. Search Members
      1.2.2.2. Filter Results
         1.2.2.2.1. Clear Filter
      1.2.2.3. Browse Results List
         1.2.2.3.1. Edit Member Profile
         1.2.2.3.1.1. Message Member
      1.2.2.4. Export CSV File
   1.2.3 Payment Transactions
      1.2.3.1. Search Transactions
      1.2.3.2. Filter Results
         1.2.3.2.1. Clear Filter
      1.2.3.3. Browse Results List
         1.2.3.3.1. View Transaction Details
      1.2.3.4. Export CSV File
   1.2.4-News Services
      1.2.4.1. Search News Feeds
      1.2.4.2. Add Feed
      1.2.4.3. Browse Results
         1.2.4.3.1. Edit Feed
         1.2.4.3.1.1. Delete Feed
         1.2.4.3.2. Activate/Deactivate Feed
         1.2.4.3.3. Subscribers List
      1.2.4.4. Activity Report
         1.2.4.4.1. Export CSV
   1.2.5. Messenger Services
      1.2.5.1. Search Complaints
      1.2.5.2. Filter Results
         1.2.5.1.1. Clear Filter
      1.2.5.3. Browse Results
         1.2.5.3.1. View Conversation
         1.2.5.3.2. Link To Member Profile
      1.2.5.4. Activity Report
   1.2.6. Calendar Services
      1.2.6.1. Add Email Gateway
      1.2.6.2. Browse Email Gateways
      1.2.6.3. Edit Email Gateway
         1.2.6.3.1. Delete Email Gateway
      1.2.6.4. Activity Report
         1.2.6.4.1. Export CSV
   1.2.7. Email Services
      1.2.7.1. Search Email Account
      1.2.7.2. Filter Results
         1.2.7.2.1. Clear Filters
      1.2.7.3. Browse Results
      1.2.7.4. Edit Email Account
         1.2.7.4.1. Replace
         1.2.7.4.2. Forward
         1.2.7.4.3. Reassign
         1.2.7.4.4. Folder Redirect
      1.2.7.5. Activate/Deactivate Email Account
   1.2.8. Folder Services
      1.2.8.1. Search Folders
      1.2.8.2. Filter Results
         1.2.8.2.1. Clear Filters
      1.2.8.3. Move Contents Between Member Folders
      1.2.8.4. Export CSV
   1.2.9. Advertiser Manager
      1.2.9.1. Advertiser Manager
         1.2.9.1.1. Search Advertiser
         1.2.9.1.2. Add Advertiser
         1.2.9.1.3. Filter Results
         1.2.9.1.3.1. Clear Filter
         1.2.9.1.4. Edit Advertiser
         1.2.9.1.4.1. Delete Advertiser
         1.2.9.1.4.2. View Statistics
         1.2.9.1.3. Export CSV
   1.2.10. Campaign Manager
      1.2.10.1.1. Search Campaign
         1.2.10.1.2. Add Campaign
         1.2.10.1.3. Filter Results
         1.2.10.1.3.1. Clear Results
         1.2.10.1.4. Edit Campaign
         1.2.10.1.5. View Campaign Ledger
         1.2.10.1.5.1. Export CSV
      1.2.10.2. Export CSV
   1.2.11. System
      1.2.11.1. Users
         1.2.11.1.1. Search Users
         1.2.11.1.2. Filter Results
         1.2.11.1.2.1. Clear Filter
         1.2.11.1.3. Add User
      1.2.11.2. Permissions
      1.2.11.3. Settings
         1.2.11.3.1. Config Settings
         1.2.11.3.1.1. Metric Tracking List items
         1.2.11.3.1.1.1. Add
         1.2.11.3.1.1.2. Browse
         1.2.11.3.1.13. Delete

Functionality

1. Interface

Login
This feature will utilize the standard DIT CMS framework;
A SUPER ADMINISTRATOR user must create an ADMINISTRATOR user type to access features and functionality; and
Users will be required to provide a validated email address and password in order to access the web application.

Password Reset
This feature will utilize the standard D T CMS framework
User can request their password to be reset by having a reset code texted to them;
The system will request their reset code and, if correctly entered, will prompt them for a new password; and
Once the password has been confirmed then a notification will be sent to the user by email indicating that their password has been changed.

Header

Logo
Refer to web application design standard.

Link to My Profile
Opens standard CMS user profile page.

Logout
Returns user to MYEMCalendar homepage.

Message Notification Badge
indicates number of messages waiting for user; and
Pop-up displays types of messages and links to source

2. Feature Menu

2.1. Subscription Services

This feature allows the user to create and manage subscription products that can be sold to members.

User Role: links to CMS User Role Type and associated privileges

Subscription & Expiry Process
The CMS back-office component will allow the administrator to manage a list of subscription programs & fees that map to a particular USER ROLE in the CMS;
The initial member type for all app users will be MEMBER—if a user attempts to use a feature that's not available within that role then they'll be prompted to visit the website and purchase an advanced subscription;
A CRON will run on a daily basis and initiate an email to expiring subscribers 30, 15, 5 and last day linking them to the subscription purchase page; and the CRON will post a timeline message from day 15 to 0 “Renew your [Program] subscription now” that links to the subscription purchase page

Search Packages
Text search {NAME}

Add Package
Allows user to enter in a new SUBSCRIPTION PROFILE

Filter Results
{Status}

Clear Filter
Remove filters

Browse Results
Allows user to scroll through current list of subscription packages

Edit Package
Allows user to modify data on the SUBSCRIPTION PROFILE page Delete Package
After confirmation of intent, the record will be removed form the table

Subscriber List
Displays a pop-up that allows user to browse through members that have subscribed to a particular package—clicking on user will open up member profile.

Export CSV
Exports a CSV file with all field data related subscribers based on the filtered results set.

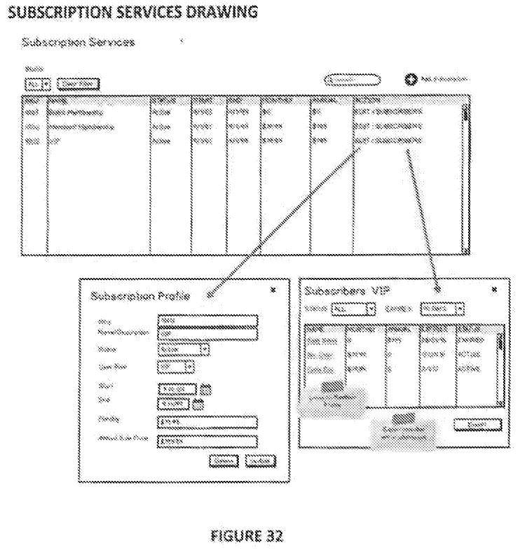

FIG. 32 is a Subscription Services Drawing

2.2 Member Manager

This feature will allow the user to administer individual members.

Search Members

This feature will allow the user to select a member from a list of filtered results.

Filters
{Joined From/To, Last Login From/To, Data Storage Amount, Membership Status}

Buttons

Export—allows user to download a CSV file complete with all fields relating to members contained within the results list.

Clear Filter—removes filters

Edit Member

Member Prose
This feature allows the user to view membership Information while modifying a member's access privileges;
Storage Limit dropdown (1 Gb, 2 Gb, 3 Gb, 4 Gb, 5 Gb);
Complaints Made/Received refers to Instant Messaging conversations reported on;

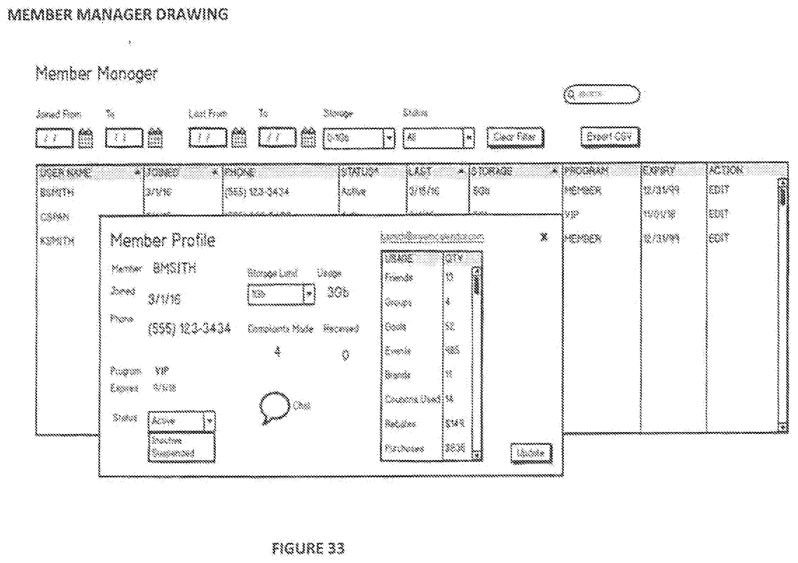

FIG. 33 is a Member Services Drawing

2.3. Payment Transactions

Gateway Transactions
This feature allows the user to browse incoming and outgoing financial transactions for a particular payment gateway;
Should there be a need to credit back an amount to a member then the user simply clicks on an icon within the line that permits a credit and confirms their intention. The payment transaction record is then updated to show that it's been refunded ensuring that the user can't credit the record again;
Search {Member, Notes, From, To};

Buttons

Clear Filter—Removes Filters

Export Transactions—This feature allows the user to export ALL table fields to a CSV file relating to the records displayed in the results list.

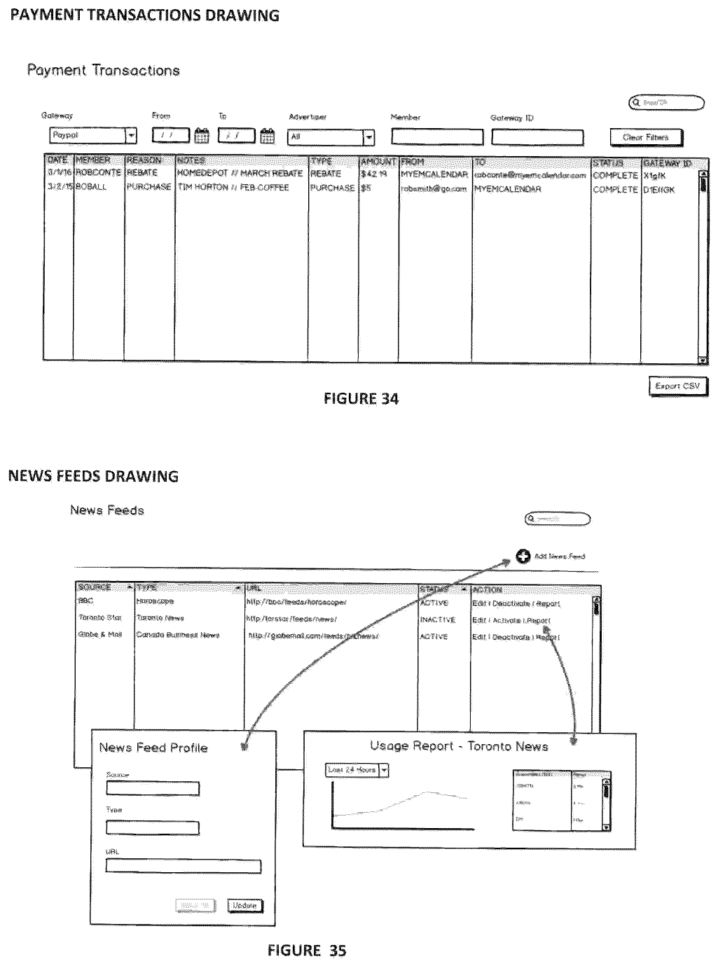

FIG. 34 is a Payment Transactions Drawing

2.4. News Services

This feature allows an administrator to manage a list of available news feeds.

General users Whit be able to subscribe to any number of news feeds by favoriting the ones that they like from a list of available RSS channels.

Default RRS news Feeds
Arts http://feeds.reuters.com/news/artsculture
Business http://feeds.reuters.com/reuters/businessNews
Company News http://feeds.reuters.com/reuters/companyNews
Entertainment http://feeds.reuters.com/reuters/entertainment
Environment http://feeds.reuters.com/reuters/environment
Health News http://feeds.reuters.com/reuters/healthNews
Lifestyle http://feeds.reuters.com/reuters/lifestyle
Media http://feeds.reuters.com/news/reutersmedia
Money http://feeds.reuters.com/news/wealth
Most Read Articles http://feeds.reuters.com/reuters/MostRead
Oddly Enough http://feeds.reuters.com/reuters/oddlyEnoughNews
Pictures http://feeds.reuters.com/ReutersPictures
People http://feeds.reuters.com/reuters/peopleNews
Politics http://feeds.reuters.com/Reuters/PoliticsNews
Science http://feeds.reuters.com/reuters/scienceNews
Sports http://feeds.reuters.com/reuters/sportsNews
Technology http://feeds.reuters.com/reuters/technologyNews
Top News http://feeds.reuters.com/reuters/topNews
US News http://feeds.reuters.com/Reuters/domesticNews
World http://feeds.reuters.com/Reuters/worldNews

Browse XML Feeds

The user will browse/edit, delete & change status of a list of available feeds.

Buttons

Add New—spawns a pop-up window to add news feed

Clear Filters—removes all search fitters

Activity Report

This feature presents a stacked bar graph aggregating how many people accessed a particular feed in last 24, 48, 72 hours;

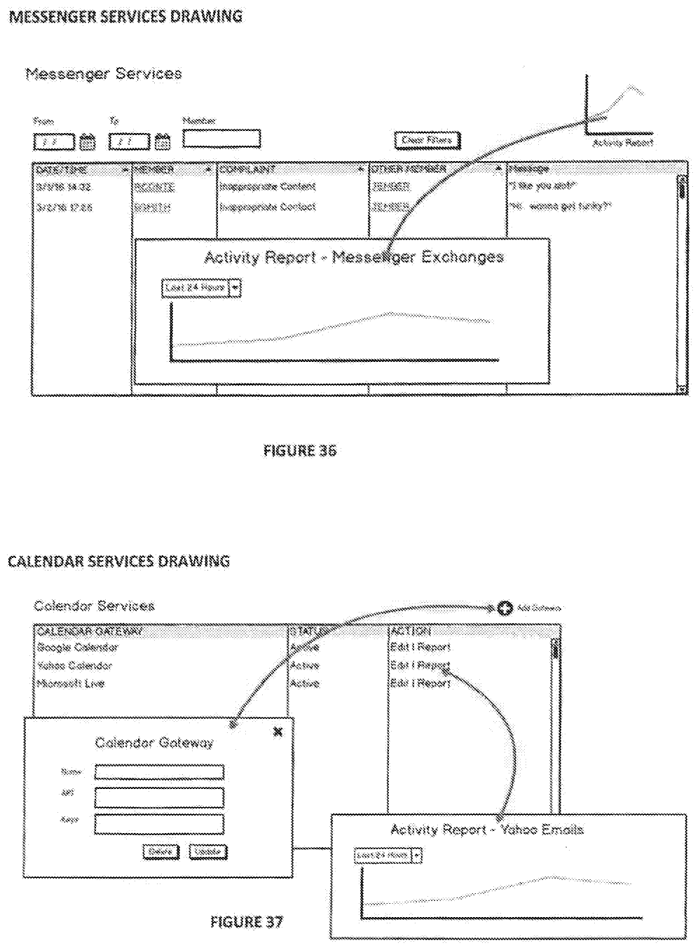

FIG. 35 is a New Feeds Drawing

5. Messenger Services

General users can initiate text messages between themselves and other community members. If the user feels threatened or annoyed by another user then they can block them and/or report a section of text interact as being inappropriate.

This feature allows administrators to monitor and respond to blocked members as well as content complaints.

Browse Complaints

This feature will allow the user to browse a list of complaints and blocked users.

Each line will have an icon allowing the user to either initiate an instant message communication with the complainant, or other user, as well as spawning a pop-up window displaying membership profile information.

Filters
{Date Range Of Conversation, Member Name}

Activity Report

The user will be able to view a graph of complaints and blocked users by month for the last 24, 48, 72 hours.

FIG. 36 is a Messenger Services Drawing

6. Calendar Services

This feature will allow administrators the ability to define what 3^{rd} party services will be made available to users.

Browse Calendar Gateways

The user will be able to browse a list of available 3^{rd} party calendar services.

Buttons

Add New—spawns a pop-up window allowing user to add 3^{rd} party calendar service.

Activity Report

The user will be able to view a graph of calendar traffic by 3^{rd} party service provider by last 24, 48 and 72 hours.

FIG. 37 is a Calendar Services Draining

7. Email Service

Upon registration, a general user will be given a unique MYEMCalendar email address based on their unique user ID—this will be referred to as their registration email address.

The user will be provided with a feature that allows them to choose an alternate MYEMCalendar email address, an alias that points back to their registration email address.

Users will also be able to associate a unique alias email address for each MEMORY BOX that they create.

Browse Email Addresses

This feature allows an administrator to search/browse all email addresses that are in circulation.

Each line will have an ion allowing the user to either initiate an instant message communication with the complainant, or other user, as well as spawning a pop-up window displaying membership profile information.

Filters
{member user name, email address, email account status}

Buttons

Clear Filters—removes filters

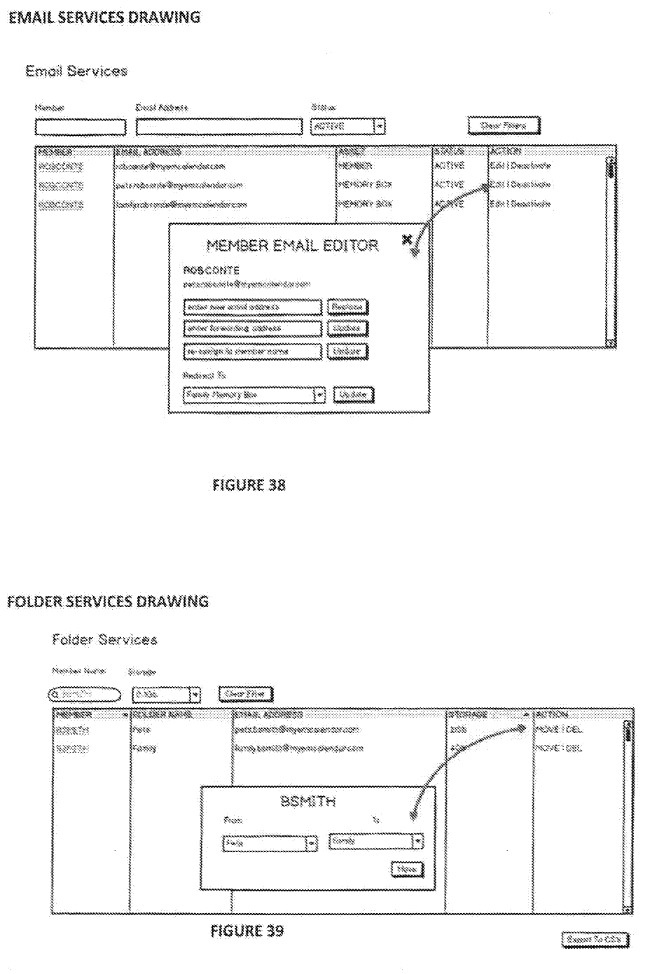

FIG. 38 is an Email Services Drawing

8. Folder Services

This feature allows the administrator to search users based on their current storage and move files from one folder to another.

Buttons

Export CV—this feature lists all users and all of their associated folders: {user name, storage limit, storage used, folder name, folder size, folder file count}

FIG. 39 is a Folder Services Drawing

9. Advertiser Manner

This feature allows the user to manage a list of people or businesses promoting products and services to the general members.

Search/Browse Advertisers

Fitters
{Advertiser Start Date Range. Last Login Date Range. Account Status}Search {Company. Contact Name}

Buttons

Export—allows user to download a CSV file complete with all fields relating to advertisers contained within the results list.

Add—allows user to add a new Advertiser profile.

Edit/Delete Advertiser Profile

This feature allows the user to view and modify all aspects of an Advertiser's membership profile, including deleting a profile.

Locations
User can import CSV file with store locations for placing on map;
CLEAR button deletes all data in table;

Statistics Generator
This feature aggregates all stats from member data tables and summarizes it here by Advertiser filtered by activity date, activity type, activity location postal code and recorded dollar value;
Export CSV (Advertiser, From, To, Member, Purchases, Favorites, Reviews, Check-Ins, Shares)

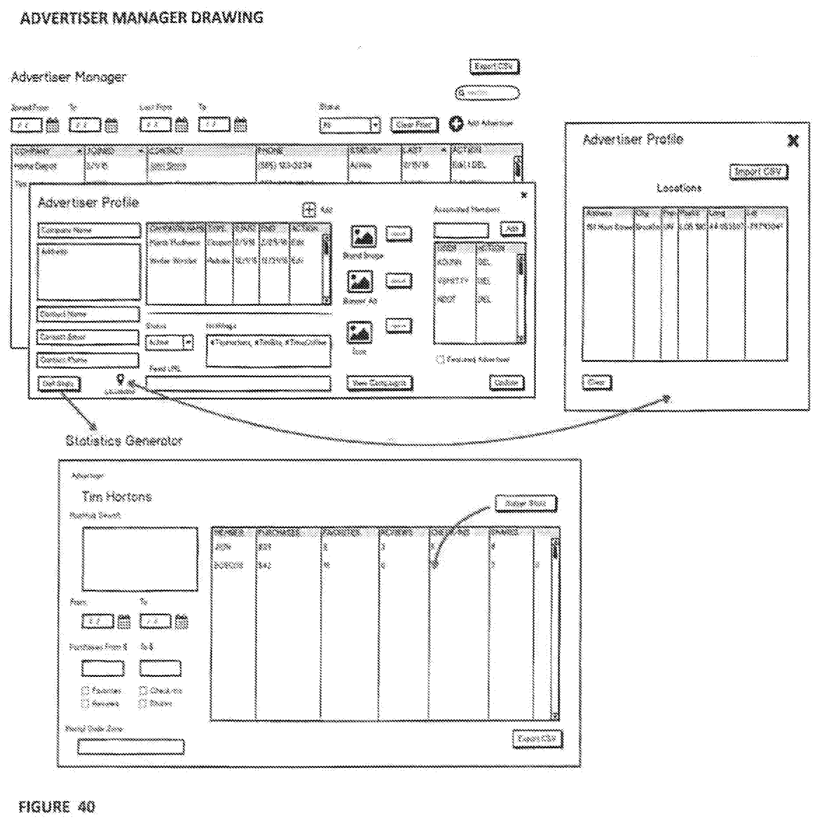

FIG. 40 is an Advertiser Manager Drawing

10. Campaign Manager

This feature allows the user to manage an Advertiser's coupon, rebate and group discount campaigns.

Search/Browse Campaigns

Filters
{Campaign Start Date, Status, Advertiser Name}

Buttons

Export—allows user to download a CSV file complete with all fields relating to campaigns contained within the results list.

Add—allows user to add a new Campaign profile.

Edit/Delete Campaign

This feature allows the user to modify all aspects of a campaign profile Including deleting it.

There 6 types of campaigns:
1. Coupon—members are issued barcoded images that can be applied to on-lime and retail store purchases;
2. Rebate—members are Issued cash-value vouchers that can be redeemed and transferred into their real-world bank accounts;
3. Grow Purchase—members can buy products and services at discounted rates providing a minimum number of buyers participate;
4. Email—members are sent promotional messages to their real-world email addresses;
5. SMS—members are texted promotional messages to their mobile phones; and
6. Proximity Ads—when members check-in to an advertiser's location they are presented with a display add promoting a discount opportunity. This feature will evolve in the next release into display ads that pop up whenever a member comes close to an advertiser's brand location.

Ad Programs

Coupon/Rebate/Discount
notification is posted to all participant timelines;
record posted to user SAVINGS table;

SMS

Descriptive text sent to user's phone numbers;

Email

DESCRIPTIVE TEXT emailed to all primary MYEMCalendar email addresses;

Proximity

When user comes within 100 metres of an Advertiser's store location (based on data stored on Advertiser profile) then the DESCRIPTIVE TEXT is sent to users phone; map pops up on app with message; and map points appear for where the user is located and the Advertiser's store;

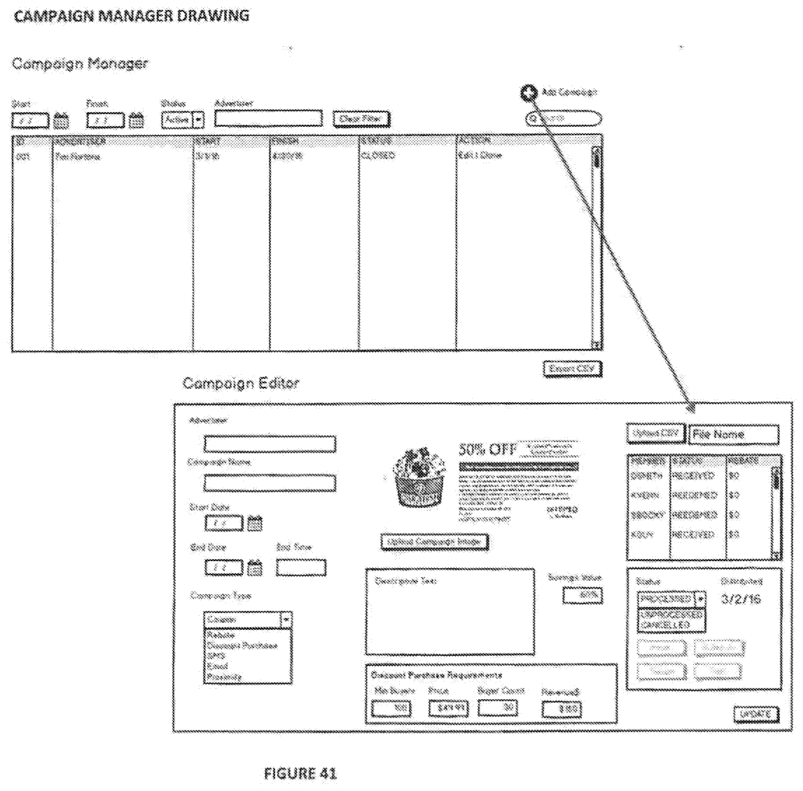

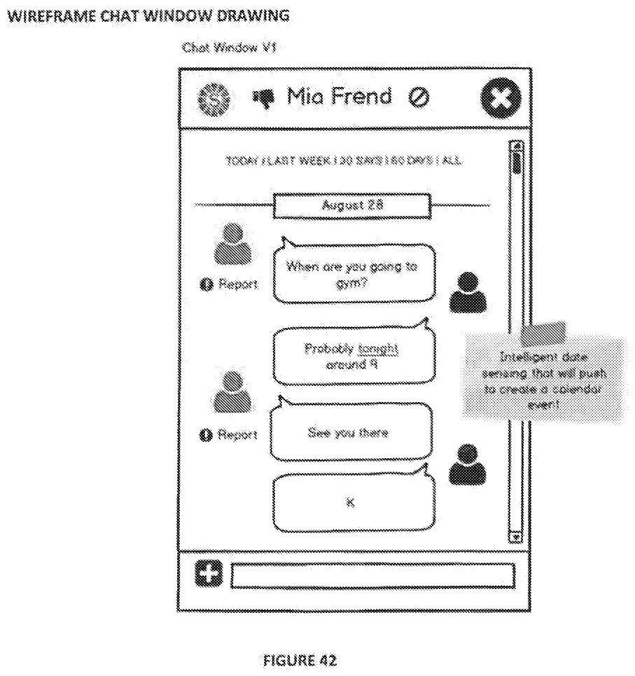

FIG. 41 is a Campaign Manager Drawing

11. System

This feature allows the user to set default values, build drop down lists, turn features on and off, etc specific to the system as a whole.

Users

Search Users
Text search name & email fields

Filter Results
Role

Clear Filter
Remove all search filters.

Add User

There is a system rule that requires users to register through the mobile app.

For the purposes of development efforts prior to the delivery of a mobile app, the administrator will be able to odd a MEMBER user role.

There are three roles:
Super Admin—master access to all features & functions
Administrator—a user with access to limited “back office” features & functions
Member—any non-administrative user

Permissions

The user can change the default privileges for all types of roles.

Settings

Config Settings

| | | |
|---|---|---|
| System Status | On/Off | If SYSTEM STATUS is OFF then |
| | | users receive a landing page |
| | | indicating that the system is a |
| | | down or maintenance rather than |
| | | login screen. |
| Chat Status | On/Off | If CHAT STATUS is OFF then users |
| | | will not see CHAT option in navigation |
| News Status | On/Off | If NEWS STATUS is OFF then users |
| | | will not see NEWS option in navigation |
| Email Status | On/Off | If EMAIL STATUS is OFF then users |
| | | will not see EMAIL option navigation |

Lists Management
Codes For Goal Tracking Unit

Platform|Web Application

The purpose of the web application is to provide convenient desk top access to a limited set of member level features and functions.

User's must be a registered mobile application user with a validated user email address end mobile phone number in order to access the web application platform.

Features
1. Interface
   1.1. News Feed
      1.1.1. Select Feed/All
   1.2. Menu
      1.2.1. Select Feature
   1.3. My Profile
   1.4. My Favorites
      1.4.1. View Timeline
   1.5. My Connections
      1.5.1. Friends
         1.5.1.1. Initiate Chat
         1.5.1.2. View Timeline
      1.5.2. Groups
         1.5.2.1. View Timeline
   1.6. My Savings
      1.6.1. Coupons
         1.6.1.1. View Opportunity
         1.6.1.1.1. Email Coupon
         1.6.1.1.1.1. Send
         1.6.1.1.2. Share with non-member
         1.6.1.1.1.1. Send
      1.6.2. Rebates
         1.6.2.1. Claim Rebate
      1.6.3. Discounts
         1.6.3.1. View Opportunity
   1.7. Logout
   1.8. Featured Advertiser Carousel
      1.8.1. Like/Unlike Select
   1.9. Notifications
      1.9.1. New Messages
      1.9.2. Calendar Reminders
2. Feature Menu
   2.1. Timeline
      2.1.1. View Timeline
         2.1.1.1. User Postings
         2.1.1.2. Friend Postings
         2.1.1.3. Advertiser Postings (Coupons, Rebates, Discounts)
         2.1.1.4. Advertiser Logo
         2.1.1.5. Product Image
      2.1.2. Post Message
         2.1.2.1. Add Photo/Video
         2.1.2.2. Add Text
         2.1.2.3. Post
         2.1.2.3.1. Intelli-link Hashtags
         2.1.2.3.2. Intelli-link Advertisers
         2.1.2.3.3. Intelli-link Advertiser Products
         2.1.2.3.4. Intelli-link Dates
      2.1.3. Respond To Message
         2.1.3.1. LIKE/NOT LIKE post
         2.1.3.2. SHARE/UNSHARE post
         2.1.3.3. CHAT with member
         2.1.3.4. NEED IT flag/unflag
         2.1.3.5. WANT IT flag/unflag
         2.1.3.6. GOT IT flag/unflag
         2.1.3.7. Rate Product
      2.1.4.
   2.2. Calendar
      2.2.1. View (Day, Week, Month, List All)
      2.2.2. Browse Events (Day, List All)
      2.2.3. Add Event
      2.2.4. Edit Event
         2.2.4.1. Event start date/time
         2.2.4.2. Event end date/time
         2.2.4.3. Location
         2.2.4.4. Comment/Note
         2.2.4.5. Assign GOAL
         2.2.4.5.1. Edit entry in GOAL ledger
         2.2.4.6. Notify Invitees
         2.2.4.7. Assign Alert
         2.2.4.8. Upload Receipt
         2.2.4.8.1. View Receipt
         2.2.4.8.2. Remove Receipt
         2.2.4.8.2.1. Delete all related FINANCE ledger entries
         2.2.4.8.3. Enter receipt total
         2.2.4.8.4. Breakout line items to FINANCE ledger
         2.2.4.8.4.1. Add Line item
         2.2.4.8.4.1.1. Select FINANCE ledger code
         2.2.4.8.4.1.2. Amount
         2.2.4.8.4.1.3. Note
         2.2.4.8.4.1.4. Update Unassigned Amount
         2.2.4.8.4.2. Delete Line Item
         2.2.4.8.4.2.1. Update Unassigned Amount
         2.2.4.8.4.3. Rate line item
         2.2.4.8.4.3.1. Post rating to timeline
         2.2.4.9. Upload Images×5
         2.2.4.9.1. View Image
         2.2.4.9.2. Assign images to MEMORY BOX
         2.2.4.10. Delete Event
         2.2.4.11. Update Event
      2.2.5. Cancel Event
         2.2.5.1. Notify Invitees
         2.2.5.2. Delete Event
      2.2.6. Drag/Move Event (Day, Week)
         2.2.6.1. Notify invitees
   2.3. Email
      2.3.1. Select Folder {Inbox, Sent, Drafts, Trash, Flagged}
         2.3.1.1. Search
         2.3.1.2. Browse (Attachments, From, Subject, Body, Date/Time)
         2.3.1.3. Flag/Unflag
         2.3.1.4. Lock/Unlock
         2.3.1.5. Select Email
         2.3.1.5.1. Flag/Unflag
         2.3.1.5.2. Lock/Unlock
         2.3.1.5.3. Trash
         2.3.1.5.4. Reply to recipient
         2.3.1.5.5. Reply to all
         2.3.1.5.6. From, To, CC, Date, Subject, Message
         2.3.1.5.7. Download attachments
         2.3.1.6. Reply
         2.3.1.6.1. From, Date, Subject, Message
         2.3.1.6.2. To, CC: Select from FRIENDs
         2.3.1.6.3. Attach file
         2.3.1.6.4. Send
         2.3.1.7. Select All
         2.3.1.7.1. Bulk Delete
      2.3.2. Settings
         2.3.2.1. Forward email
         2.3.2.2. Assign email address to folder
         2.3.2.3. Update
   2.4. To-dos
      2.4.1. Tasks
      2.4.2. Add New
      2.4.3. Browse
         2.4.3.1. Mark as complete
         2.4.3.1.1. Update Goal Ledger
         2.4.3.1.2. Update
         2.4.3.2. Delete
      2.4.4. Checklists
         2.4.4.1. Add new
         2.4.4.2. Add task
         2.4.4.2.1. Delete task
         2.4.4.3. Delete
         2.4.4.4. Activate
   2.5. Favorites
      2.5.1. Select Favorite Advertiser
         2.5.1.1. Logo
         2.5.1.2. Activity summary {receipts, rebates, discount savings}
         2.5.1.3. Favorite locations
         2.5.1.4. Reviewed products
         2.5.1.5. Go to advertiser timeline
   2.6. Goals
      2.6.1. Lifestyle Categories
         2.6.1.1. Select
      2.6.2. Ledger
         2.6.2.1. Clear SELECT LIFESTYLE filter
         2.6.2.2. Add Goal
         2.6.2.3. Browse Goals
         2.6.2.3.1. Edit Goal
         2.6.2.3.1.1.1. Goal Profile
         2.6.2.3.1.1.1.1. Add Calendar Event
         2.6.2.3.1.1.2. Browse Activity Ledger
         2.6.2.3.1.1.2.1. Add activity
         2.6.2.3.1.1.2.2. Delete activity
         2.6.2.3.1.1.3. Update Goal
         2.6.2.3.2. Delete Goal
         2.5.2.3.3. Finances
         2.6.2.3.4. Memory Boxes
   2.7. Finances
      2.7.1. Accounts
         2.7.1.1. Add Account
         2.7.1.2. Set Reporting Period
         2.7.1.3. Browse Accounts
         2.7.1.4. Edit Account
         2.7.1.4.1. Name
         2.7.1.4.2. Assign To Group
         2.7.1.4.3. Delete
         2.7.1.4.4. Update
      2.7.2. Groups
         2.7.2.1. Add Group
         2.7.2.2. Delete Group
         2.7.2.3. Browse Groups
         2.7.2.4. Export CSV
      2.7.3. Activity Ledger
         2.7.3.1. Add Activity
         2.7.3.2. Filter Account or Group
         2.7.3.3. Browse Activities
         2.7.3.3.1. Edit Activity
         2.7.3.3.1.1. {Date, Account, Amount, Note, Tags}
         2.7.3.3.1.2. Rating
         2.7.3.3.1.2.1. Post to timeline
         2.7.3.3.1.3. Add Receipt
         2.7.3.3.1.3.1. View Receipt
         2.7.3.3.1.3.2. Remove Receipt
         2.7.3.3.2. Update
         2.7.3.3.3. Delete
         2.7.3.3.4. Clone
         2.7.3.4. Export CSV
      2.7.4. Ledger
      2.7.5.
   2.8. Memories
      2.8.1. Search
         2.8.1.1. Text Search (location, event, tag, name)
      2.8.2. Select Folder
         2.8.2.1. Add File
         2.8.2.2. View Image
         2.8.2.3. Add Picture
         2.8.2.4. Multi-image Select
         2.8.2.4.1. Delete
         2.8.2.4.2. Move
         2.8.2.5. Select image
         2.8.2.5.1. File Property
         2.8.2.5.1.1. Name
         2.8.2.5.1.2. Tags
         2.8.2.5.1.3. Email
         2.8.2.5.1.4. Post To Timeline
         2.2.2.5.1.5. Update
         2.8.2.5.1.6. Delete

### Platform|Mobile App

Features
1. Interface
   1.1. Login
      1.1.1. Registration
         1.1.1.1. SMS Verification
      1.1.2. Password Reset
         1.1.2.1. SMS
         1.1.2.2. Email
      1.1.3. Notifications On/Off
      1.1.4. My Profile
         1.1.4.1. Notifications Or/Off
         1.1.4.2. Invisible/Visible To Friend Searches
         1.1.4.3. Forwarding Mail Address
         1.1.4.3.1. Verify Forwarding Email Address
         1.1.4.4. 3^{rd} Party Calendar Sync URL
         1.1.4.5. Help Desk Link
         1.1.4.6. Close Account
      1.1.5. Logout
2. Feature Menu
   2.1. Timeline
      2.1.1. Take/Select Image For Posting
      2.1.2. Post To Timeline
      2.1.3. Review Timeline
         2.1.3.1. Share Post
         2.1.3.2. Like Post
         2.1.3.3. Initiate Chat With User
         2.1.3.4. Rate Product Reference
   2.2. News Feeds
      2.2.1. Subscribe/Unsubscribe To Feed
      2.2.2. Set Time Period
      2.2.3. Notifications On/Off
      2.2.4. Browse Headlines
      2.2.5. Read Article
         2.2.5.1. Like (Share To Timeline)
   2.3. Relations
      2.3.1. Friends
         2.3.1.1. My Status
         2.3.1.2. Chat Notification On/Off
         2.3.1.3. Search Members
         2.3.1.4. Send Friend Request
         2.3.1.4.1. Notify ‘Friend’ Member
         2.3.1.4.2. Send Friend Acceptance Notification To Sender
         2.3.1.5. Search Friends
         2.3.1.6. Browse Friends
         2.3.1.6.1. View Friend Profile
         2.3.1.6.1.1. Unfriend
         2.3.1.6.1.2. View Timeline
         2.3.1.6.1.3. Initiate Phone Call
         2.3.1.6.1.4. Send Email
         2.3.1.6.1.5. Initiate Chat
         2.3.1.6.1.6. Browse Common Calendar Events
      2.3.2. Groups
         2.3.2.1. Search Groups
         2.3.2.2. Subscribe To Group
         2.3.2.3. View Group Timeline
         2.3.2.3.1. Unsubscribe
         2.3.2.3.2. Set Time Period
         2.3.2.3.3. Browse Posts
         2.3.2.3.4. Like Post
         2.3.2.3.5. Post image
         2.3.2.3.6. Post Text Message
      2.3.3. Favorites
         2.3.3.1. Search Advertisers
         2.3.3.2. Add Advertiser To Favorites
         2.3.3.3. Search Favorites
         2.3.3.4. View Favorite
         2.3.3.4.1. Like/Unlike
         2.3.3.4.2. Locations
         2.3.3.4.3. Savings
         2.3.3.4.4. Timeline
         2.3.3.4.5. My Check-in
   2.4. My Time
      2.4.1. Calendar
         2.4.1.1. View {Day, Week, Month, List All}
         2.4.1.2. Browse Events (Day, List All)
         2.4.1.3. Add Event
         2.4.1.4. Edit Event
         2.4.1.4.1. Event start date/time
         2.4.1.4.2. Event end date/time
         2.4.1.4.3. Location
         2.4.1.4.4. Comment/Nate
         2.4.1.4.5. Assign GOAL
         2.4.1.4.5.1. Edit entry in GOAL ledger
         2.4.1.4.6. Notify Invitees
         2.4.1.4.7. Assign Alert
         2.4.1.4.8. Upload Receipt
         2.4.1.4.8.1. View Receipt
         2.4.1.4.8.2. Remove Receipt
         2.4.1.4.8.2.1. Delete all related FINANCE ledger entries
         2.4.1.4.8.3. Enter receipt total
         2.4.1.4.8.4. Breakout line items to FINANCE ledger
         2.4.1.4.8.4.1. Add Line Item
         2.4.1.4.8.4.1.1. Select FINANCE ledger code
         2.4.1.4.8.4.1.2. Amount
         2.4.1.4.8.4.1.3. Note
         2.4.1.4.8.4.1.4. Update Unassigned Amount
         2.41.4.8.4.2. Delete Line Item
         2.4.14.8.4.2.1. Update Unassigned Amount
         2.4.1.4.8.4.3. Rate line item
         2.4.1.4.8.4.3.1. Post rating to timeline
         2.4.1.4.9. Upload Images×5
         2.4.1.4.9.1. View Image
         2.4.1.4.9.2. Assign images to MEMORY BOX
         2.4.1.4.10. Delete Event
         2.4.1.4.11. Update Event
         2.4.1.5. Cancel Event
         2.4.1.5.1. Notify Invitees
         2.4.1.5.2. Delete Event
         2.4.1.6. Drag/Move Event (Day, Week)
         2.4.1.6.1. Notify Invitees
   2.5. Email
      2.5.1. Select Folder {Inbox, Sent, Drafts, Trash, Flagged}
         2.5.1.1. Search
         2.5.1.2. Browse {Attachments, From, Subject. Body, Date/Time}
         2.5.1.3. Flag/Unflag
         2.5.1.4. Lock/Unlock
         2.5.1.5. Select Email
         2.5.1.5.1. Flag/Unflag
         2.5.1.5.2. Lock/Unlock
         2.5.1.5.3. Trash
         2.5.1.5.4. Reply to recipient
         2.5.1.5.5. Reply to all
         2.5.1.5.6. From, To, CC, Date, Subject, Message
         2.5.1.5.7. Download attachments
         2.5.1.6. Reply
         2.5.1.6.1. From, Date, Subject, Message
         2.5.1.6.2. To, CC: Select from FRIENDs
         2.5.1.6.3. Attach file
         2.5.1.6.4. Send
         2.5.1.7. Select All
         2.5.1.7.1. Bulk Delete
      2.5.2. Settings
         2.5.2.1. Forward email
         2.5.2.2. Assign email address to folder
         2.5.2.3. Update
   2.6. To-dos
      2.6.1. Tasks
      2.6.2. Add New
      2.6.3. Browse
         2.6.3.1. Mark as complete
         2.6.3.1.1. Update Goal Ledger
         2.6.3.1.2. Update
         2.6.3.2. Delete
      2.6.4. Checklists
         2.6.4.1. Add new
         2.6.4.2. Add task
         2.6.4.2.1. Delete task
         2.6.4.3. Delete
         2.6.4.4. Activate
   2.7. Favorites
      2.7.1. Select Favorite Advertiser
         2.7.1.1. Logo
         2.7.1.2. Activity summary (receipts, rebates, discount savings)
         2.7.1.3. Favorite locations
         2.7.1.4. Reviewed products
         2.7.1.5. Go to advertiser timeline
   2.8. Goals
      2.8.1. Lifestyle Categories
         2.8.1.1. Select
      2.8.2. Ledger
         2.8.2.1. Clear SELECT LIFESTYLE filter
         2.8.2.2. Add Goal
         2.8.2.3. Browse Goals
         2.8.2.3.1. Edit Goal
         2.8.2.3.1.1.1. Goal Profile
         2.8.2.3.1.1.1.1. Add Calendar Event
         2.8.2.3.1.1.2. Browse Activity Ledger
         2.8.2.3.1.1.2.1. Add activity
         2.8.2.3.1.1.2.2. Delete activity
         2.8.2.3.1.1.3. Update Goal
         2.8.2.3.2. Delete Goal
         2.8.2.3.3. Finances
         2.8.2.3.4. Memory Boxes
   2.9. Finances
      2.9.1. Accounts
         2.9.1.1. Add Account
         2.9.1.2. Set Reporting Period
         2.9.1.3. Browse Accounts
         2.9.1.4. Edit Account
         2.9.1.4.1. Name
         2.9.1.4.2. Assign To Group
         2.9.1.4.3. Delete
         2.9.1.4.4. Update
      2.9.2. Groups
         2.9.2.1. Add Group
         2.9.2.2. Delete Group
         2.9.2.3. Browse Groups
         2.9.2.4. Export CSV
      2.9.3. Activity Ledger
         2.9.3.1. Add Activity
         2.9.3.2. Filter Account or Group
         2.9.3.3. Browse Activities
         2.9.3.3.1. Edit Activity
         2.9.3.3.1.1. {Date, Account, Amount, Note, Tags}.
         2.9.3.3.1.2. Rating
         2.9.3.3.1.2.1. Post to timeline
         2.9.3.3.1.3. Add Receipt
         2.9.3.3.1.3.1. View Receipt
         2.9.3.3.1.3.2. Remove Receipt
         2.9.3.3.2. Update
         2.9.3.3.3. Delete
         2.9.3.3.4. Clone
         2.9.3.4. Export CSV
      2.9.4. Ledger
   2.10. Memories
      2.10.1. Search
         2.10.1.1. Text Search (location, event, tag, name)
      2.10.2. Select Folder
         2.10.2.1. Add File
         2.10.2.2. View image
         2.10.2.3. Add Picture
         2.10.2.4. Multi-image Select
         2.10.2.4.1. Delete
         2.10.2.4.2. Move
         2.10.2.5. Select image
         2.10.2.5.1. File Property
         2.10.2.5.1.1. Name
         2.10.2.5.1.2. Tags
         2.10.2.5.1.3. Email
         2.10.2.5.1.4. Post To Timeline
         2.10.2.5.1.5. Update
         2.10.2.5.1.6. Delete
   2.11. My Journey
      2.11.1. Create Journey
      2.11.2. Browse Journeys
         2.11.2.1. View Journey
         2.11.2.1.1. Start Journey
         2.11.2.1.2. Check-in
         2.11.2.1.2.1. Instore Pop-up Coupon
         2.11.2.1.2.2. Instore Flash Sale Text Message
         2.11.2.1.3. Stop Journey
         2.11.2.1.4. Delete Journey

### Chat & TimeLine

Chat Window

The chat/instant messaging feature allows users to send messages back and forth with real-time notifications.

Features
Select Time Period
Like/Unlike (Unfriend) Member
Block/Unblock Member
Report Conversation
Post Text Message
Close Window

Intelli-Links

Post text will be evaluated and the following actions Initiated:
Known products—will allow user to rate product and display Need, Want, Got It;
Known advertisers—will link to Advertiser timeline;
Dates & Times—will create events if clicked;

### Awing

Time Line

The timeline is an aggregate index of person's life-journey within the MYEMCalendar experience. It is like personal voice recorder that documents what they've done and who they've met along the way:
I went somewhere;
   took action;
   I bought something;
      I rated something
   I saw something;
I connected with someone;
I joined a group;
   I want to share something;
I saved money; and
I made money
I posted a savings opportunity (Advertiser)

Features

Start Date
The timeline will initially open with TODAY's messages, along the user to scroll back through history; or
The user can select a day to start on;

Search
The user can search through the text content of the posting table, including the name of the person that created the post;

Privacy Polity

This feature will allow user to control the default privacy status for each of these post types:
I went somewhere;
   took action;
   I bought something;
      I rated something
   I saw something;
I connected with someone;
I joined a group;
   I want to share something;
I saved money; and
I made money

Post
User Image;
User Name (links to user timeline);
Date/Time Stamp;
Like/Unlike (Friend/Unfriend) User,
initiate Chat With User;
Post Image (only one image/video link per post);
Post Text
Post Feedback Rating (4 Star Selection);
Need, Want, Got It (Radio Button);
Like/Unlike;
Product Gallery;
Brand Logo; and
Private/Public

Intelli-Links

Post text will be evaluated and the following actions initiated:
Known products—will allow user to rate product and display Need, Want, Got It;
Known advertisers—will link to Advertiser timeline;
Dates & Times—will create events if clicked;

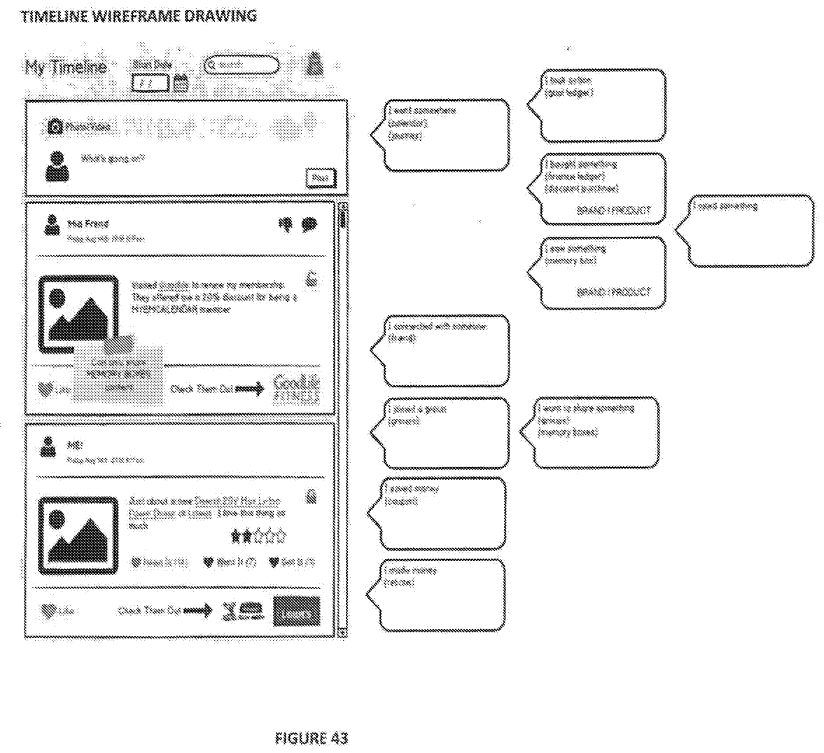

FIG. 43 is a Timeline Wireframe Drawing

### Notification Templates

Security

Welcome Message

Thank you, [First Name], for joining the MYEMCalendar community.

We've set up your account and look forward to hearing great stories about how MYEMCalendar has helped you achieve the life that you've always dreamed about.

Please check out our help resources at (URL) to get you started.

Regards,

Rob Conte

President & Founder

Lockout Notification

[First Name], your account is temporarily locked out for about 5 minutes because someone failed to enter the correct credentials after 3 tries.

If you did not cause this then send an email Immediately towand paste in this code [passwordresetcode] to reset your password, again.

Password Reset

[First Name], we've received a request to change your accounts master password.

If you did not request a change then send an email immediately to and paste in this code [passwordresetcode] to reset your password again.

Otherwise, use that code to reset your password either on your mobile app or through the website.

Expiry Email

[First Name], your current [program name] subscription expires in [count] days.

Please visit [link] and renew, today, to keep your member privileges. If we don't hear from you then we'll still provide you with a limited access free account.

Thank you for being a MYEMCalendar Member.

Cancellation Notice

We've received your request to close your account. Please click on the link below to confirm your Intentions.

[CloseTheAccountlink]

We will hold your account history for 30 days—all you have to do is log in as you normally would and your membership will be restored.

If there's something we could do in the mean time to keep you connected then please email me, personally.

Rob Conte

rob@myemcalendar.com

Founder & CEO

Social Networking

Message Notification

[First Name], [OtherUserName] has sent you a message.

Please check your inbox junk) to read and respond to it.

Posting Notification

[First Name], [OtherUsername] has just posted a message on your timeline.

Storage Notifications

100 Mb Warning

[First Name], your storage capacity is almost full—there's only 100 Mb left.

No uploads or emails with attachments will be accepted.

0 Mb Warring

[First Name], your storage capacity is used up.

No uploads or emails with attachments will be accepted.

Savings Notifications

Savings Notification—Coupon

[First Name], [Advertiser] has just posted a coupon in your SAVINGS BANK [link] saving you [CampainBenefit].

You only have [expirydays] to use this so apply it soon

Savings Notification—Rebate

[First Name], congratulations!

[Advertiser] has just sent you a cash rebate in the amount of $[rebateamount].

Visit your SAVINGS BANK [link] now and redeem your cash voucher.

Savings Notification—Group Discount

[First Name], [Advertiser] has just offered our community [discountdollars] off the purchase of a [itemdescription]. That's a savings of [discountsavingsamount] if [buyersrequired] people buy it in the next [discountminutes]. So, please visit your SAVINGS BANK [link] right now to learn more about this exciting offer

Savings Notification—Group Purchase

[First Name], thank you for purchasing a(n) [itemdescription]. We still need [buyersneeded] so please pass on the opportunity to your MYEMCalendar friends.

Savings Notification—Cancellation

[First Name], unfortunately we didn't get enough people to take advantage of [Advertiser] taking [discountdollars] off the purchase of a [itemdescription].

We've cancelled your order and refunded your $[amount].

Calendar Events

[First Name], this is the reminder that you asked MYEMCalendar to give you regarding an event scheduled for [time] [date] at [location] with [invitee]

The MYEMCalendar Lifestyle Management System—Feature Chart V2a/ Feb. 18, 2016
1. User App
2. Back Office
3. XML Feed Engine (News, Horoscopes)
4. Chat/IM Engine
5. Users
6. Advertisers
7. Programs
8. User Folder Engine
9. Email Engine
10. Calendar Engine
11. My Info Fees
12. My Groups
13. # Hashtag
14. Favorites
15. My Friends
16. My Checkins
17. My Brands
18. Favorites
19. Location (Where)
20. Task/Event (when, what, who)
21. Objective (Tag, Amount, Date)
22. My Goals
23. My Calendar
24. Product Review
25. Receipt
26. Budget Category (Tag, Amount, Month)
27. My Finances
28. My Memories
29. Folder API/Drag Drop
30. My Savings
31. Coupon
32. Rebate
33. Discount Offer
34. Campaign
35. My Travel Log
36. 3^{rd} Party Calendar Sync
37. Calendar Service
38. Email Service
39. Workstation Browser
40. Mobile/App File/Link Save
41. Paypal/Bitcoin

What is claimed is:

1. A software product for a user to set and track lifestyle goals and related activities while collecting memories data along the way, and for a business, to gather and aggregate statistics about the users lifestyle choices and offer access to the user's lifestyle choices for a fee; comprising
a) matching the following through the internet:
(i) consumers and brands that interact together, through social media designed on the software product;
(ii) the user managing receipts & expenses, goal setting and budgeting;
(iii) brands to increase consumer loyalty and market awareness;
(iv) organizing the user life, memories; and
(v) assisting the business to organize, market, and advertise and meet business goals.

2. The software product as claimed in claim 1 comprising:
(a) a data base to document a users life with a timeline that collects private and public information from data collected when the user interacts with the software product;
(b) a calendar;
(c) email Inbox;
(d) to-do's & checklists;
(e) goal management;
(f) bookkeeping;
(g) a collection of user folders, defining Memory Boxes, with an assigned email address to which the user can send documents to; and
(h) locations tracked on recorded Journeys.

3. The software product as claimed in claim 2 wherein said Memory Boxes comprise a database for gathering information about a user's time and resources invested and producing improvement date.

4. The software product as claimed in claim 3 comprising; collecting and storing images and files to said Memory Boxes to provide the user a visual and/or textual history.

5. The software product as claimed in claim 4 wherein said Memory Box included metadata with source and date.

6. The software product as claimed in claim 5 including a GPS logging system of recording locations during selected time periods.

7. A software system for a user to set and track lifestyle goals and related activities while collecting memories data along the way, and for a business, to gather and aggregate statistics about the user's lifestyle choices and offer access to the user's lifestyle choices for a fee; comprising
a) the internet:
b) a software platform for matching
(i) consumers and brands that interact together, through social media designed on the software system;
(ii) the user managing receipts & expenses, goal setting and budgeting;
(iii) brands to increase consumer loyalty and market awareness;
(iv) organizing the user life, memories; and
(v) assisting the business to organize, market, and advertise and meet business goals.

8. The software system as claimed in claim 7 comprising:
(a) a data base to document a user's life with a timeline that collects private and public information from data collected when the user interacts with the software product;
(b) a calendar;
(c) email Inbox;
(d) to-do's & checklists;
(e) goal management;
(f) bookkeeping;
(g) a collection of user folders, defining Memory Boxes, with an assigned email address to which the user can send documents to; and
(h) locations tracked on recorded Journeys.

9. The software system as claimed in claim 8 wherein said Memory Boxes comprise a database for gathering information about a user's time and resources invested and producing improvement data.

10. The software system as claimed in claim 9 comprising; a device for collecting and storing images and files to said Memory Boxes to provide the user a visual and textual history.

11. The software product as claimed in claim 10 wherein said Memory Box includes metadata with source and date.

12. The software product as claimed in claim 11 including a GPS logging device for recording locations during selected time periods.

13. A method on a mobile platform for a user to set and track lifestyle goals and related activities while collecting memories data along the way, and for a business, to gather and aggregate statistics about the user's lifestyle choices and offer access to the user's lifestyle choices for a fee; comprising
a) matching the following through the internet:
(i) consumers and brands that interact together, through social media designed with the method;
(ii) the user managing receipts & expenses, goal setting and budgeting;
(iii) brands to increase consumer loyalty and market awareness;
(iv) organizing the user life, memories; and
(v) assisting the business to organize, market, and advertise and meet business goals.

13. The method as claimed in claim 1 comprising:
(a) documenting a user's life in a data base with a timeline that collects private and public information front data collected when the user interacts with a mobile platform;
(b) generating a calendar;
(c) providing an email inbox;
(d) providing a to-do's & checklists;
(e) providing goal management;
(f) providing bookkeeping;
(g) generating a collection of user folders, defining Memory Boxes, with an assigned email address to which the user can send documents to; and
(h) tracking locations on documented Journeys.

14. The method as claimed in claim 13 wherein said Memory Boxes comprise a database for gathering information about a user's time and resources invested and producing improvement data.

15. The method as claimed in claim 14 comprising; collecting and storing images and files to said Memory Boxes to provide the user a visual and/or textual history.

16. The method as claimed in claim 15 wherein said Memory Box included metadata with source and date.

17. The method as claimed in claim 16 including a GPS logging system of recording locations during selected time periods.
